(19) United States
(12) Patent Application Publication
(10) Pub. No.: US 2012/0112966 A1
(43) Pub. Date: May 10, 2012

(54) WIDE BAND ANTENNA

(75) Inventors: Hiroiku Tayama, Chiba (JP); Ning Guan, Chiba (JP)

(73) Assignee: FUJIKURA LTD., Tokyo (JP)

(21) Appl. No.: 13/240,198

(22) Filed: Sep. 22, 2011

Related U.S. Application Data
(63) Continuation of application No. PCT/JP2009/063698, filed on Jul. 31, 2009.

(30) Foreign Application Priority Data
Mar. 31, 2009 (JP) 2009-085362

(51) Int. Cl. H01Q 1/38

(52) U.S. Cl. 343/700 MS

(57) ABSTRACT

An object of the invention is to provide a small antenna which can cope with a wide band as well as has radiation characteristics stable in the wide band.

The wide band antenna according to the invention is a wide band antenna in which a second radiation element and a first radiation element are disposed on the same substrate, and the substrate is bent on a straight line which is approximately parallel with a first straight line A approximately parallel with the disposition direction of the second radiation element and the first radiation element or rolled in a cylindrical shape which uses a straight line approximately parallel with the first straight line A as an axis direction. A power supply cable is disposed in parallel with the first straight line A.

### CROSS-REFERENCES TO RELATED APPLICATIONS

This application is a continuation of International Application PCT/JP2009/063698, filed on Jul. 31, 2009, the disclosure of which is incorporated herein by reference in its entirety. This application claims priority under 35 U.S.C. §119 to Japanese Patent Application No. 2009-085362, filed on Mar. 31, 2009, the disclosure of which is incorporated herein by reference in its entirety.

### BACKGROUND

1. Technical Field

The invention relates to a wide band antenna and in particular to a wide band antenna for UWB (Ultra Wide Band).

2. Description of Related Art

Attention has been paid to a wireless communication making use of UWB as a large capacity communication means in an ultra-wide band. It was approved by FCC (Federal Communications Commission) Standard, USA in 2002 to use UWB from 3.1 GHz to 10.6 GHz.

A small structure having an ultra-wide band is required to an antenna used in an UWB communication. To satisfy the requirement, an antenna in which a second radiation element and a first radiation element are disposed on the same surface is proposed (refer to, for example, Patent Document 1).

Ina conventional antenna, a second radiation element and a first radiation element are disposed on the same surface, a loop is formed to the second radiation element, and the area of the first radiation element is made larger than the second radiation element. With the configuration, VSWR (Voltage Standing Wave Ratio) is made to 2 or less in a frequency band of about 3 GHz or more.

A lot of small wide band antennas are proposed. Exemplified are antennas having a three-dimensional structure such as a bicortical antenna (refer to, for example, Nonpatent Document 1) and a discone antenna, (refer to, for example, Nonpatent Document 2), antennas having a planar structure such as a planar bow-tie monopole (refer to, for example, Nonpatent Document 3), a planar square dipole (refer to, for example, Nonpatent Document 4), and an elliptical monopole (refer to, for example, Nonpatent Document 5), a monopole in which a planar square radiation element is rolled in a roll shape (refer to, for example, Nonpatent Document 6), and the like.

### Prior Art Documents

### Patent Document

Patent Document 1: Japanese Patent Application Laid-Open No. 2007-235404

### Nonpatent Documents

Nonpatent Document 1: S. N. Samaddar and E. L. Mokole, “Biconical antennas with unequal cone angles”, IEEE Trans. Antennas Propagat., vol. 46, no. 2, pp. 181-193, 1998

Nonpatent Document 2: S. S. Sandler and R. W. P. King, “Compact conical antennas for wideband coverage”, IEEE Trans. Antennas Propagat., vol. 42, no. 3, pp. 436-439, 1994

Non-Patent Document 3: K. L. Shlager, G. S. Smith, and J. G. Maloney, “Optimization of bow-tie antennas for pulse radiation”, IEEE Trans. Antennas Propagat., vol. 42, no. 7, pp. 975-982, 1994

Nonpatent Document 4: X. H. Wu and Z. N. Chen, “Comparison of planar dipoles in UWB applications”, IEEE Trans. Antennas Propagat., vol. 53, no. 6, pp. 1973-1983, 2005

Nonpatent Document 5: N. P. Agrawall, G. Kumar, and K. P. Ray, “Wide-band planar monopole antenna”, IEEE Trans. Antennas Propagat., vol. 46, no. 2. pp. 294-295, 1998

Nonpatent Document 6: Z. N. Chen“, Broadband roll monopole”, IEEE Trans. Antennas Propagat., vol. 51, no. 11, pp. 3175-3177, 2003

### SUMMARY

It is required that an antenna mounted on a small wireless communication terminal is small and can cope with a wide band. Further, it is preferable that the antenna can be easily manufactured. An UWB communication requires a radiation pattern stable throughout a wide band.

However, a bias occurs in directionality in a conventional antenna.

Further, an antenna having a conventional three-dimensional structure cannot be easily manufactured. Since a conventional antenna having a planar structure has a large area, it is difficult to mount the antenna on a small wireless communication terminal. Further, in a conventional antenna, since a radiation pattern is greatly varied when an operation frequency changes, the conventional antenna cannot be applied to the UWB communication. Since a conventional monopole made by rolling a planar square radiation element in a roll shape is made by rolling a simple radiation element, the operating band of the monopole is limited. Further, the monopole may not be suitable for mass production because it is rolled only in the roll shape as a method of rolling.

Thus, an object of the invention is to provide an antenna which is small and can cope with a wide band as well as has stable radiation characteristics throughout a wide band.

Inventors have discovered by experiment that, in a wide band antenna in which a second radiation element and a first radiation element are disposed on the same surface, when the antenna is bent or rolled in a cylindrical shape about a disposition direction where the second radiation element and the first radiation element are disposed, non-directionality is improved.

A wide band antenna according to the invention includes: a first radiation element; and a second radiation element, wherein there is a characteristic that the second radiation element is bent on a first straight line which is approximately parallel with the disposition direction of the second radiation element and the first radiation element or rolled in a cylindrical shape using a straight line approximately parallel with the first straight line as an axis direction.

When the second radiation element is bent or rolled, the antenna can be made small as well as the radiation characteristics of the antenna can be improved. Further, since the antenna can be manufactured by bending or rolling a planar antenna formed of a metal film, the antenna can be easily manufactured. Accordingly, the invention can provide an antenna which is small and can cope with a wide band as well as has radiation characteristics stable throughout the wide band and further can be easily manufactured.

Specifically, in the wide band antenna according to the invention, the second radiation element and the first radiation element are disposed on the same surface, wherein there is a characteristic that the second radiation element and the first radiation element are bent on a straight line which is approximately parallel with the disposition direction of the second radiation element and the first radiation element or rolled in a cylindrical shape using a straight line approximately parallel with the first straight line as an axis direction.

The configuration according to the invention can improve non-directionality in a wide band antenna in which a second radiation element and a first radiation element are disposed on the same surface. Further, since the antenna can be mounted on information terminal equipment in a state that the second radiation element and the first radiation element are bent or rolled, the information terminal equipment can be made small.

In the wide band antenna according to the invention, it is preferable that the second radiation element and the first radiation element are formed in a loop shape; the shapes of the outer peripheries of the second radiation element and the first radiation element are line-symmetrical to the first straight line; and the shapes of the outer peripheries of the second radiation element and the first radiation element in a proximity portion where the second radiation element confronts the first radiation element are line-symmetrical to a second straight line orthogonal to the first straight line.

It has been confirmed by experiment that the non-directionality of an antenna is improved by the configuration according to the invention. Further, it has been confirmed by experiment that the areas of a first radiation element and a second radiation element can be made to the same area by the configuration according to the invention. Accordingly, the non-directionality of a wide band antenna can be improved and the wide band antenna can be made small by the invention.

In the wide band antenna according to the invention, it is preferable that the proximity portion where the second radiation element confronts the first radiation element further includes a first convex portion in which a part of the outer periphery of the first radiation element is formed in a convex shape and a second convex portion in which a part of the outer periphery of the second radiation element is formed in a convex shape; and the edges of the first convex portion and the second convex portion which confront each other are parallel with each other.

It has been confirmed by experiment that the non-directionality of an antenna is improved by the configuration according to the invention. Accordingly, it is possible to improve the non-directionality of a wide band antenna by the invention.

In the wide band antenna according to the invention, it is preferable that, as the distance between the second radiation element and the first radiation element increases, the width of the second radiation element is increased from the position where the second radiation element is nearest to the first radiation element to the position of a predetermined height in the disposition direction of the second radiation element and the first radiation element; and when the wavelength of a minimum operating frequency is shown by λ₀, the width of a projected shape of the second radiation element in the disposition direction of the second radiation element and the first radiation element is 0.12λ₀ or more to 0.5λ₀ or less in a lateral width.

When the lateral width of a second radiation element is 0.12λ₀ or more, an increase of a minimum operating frequency due to coupling caused by bending or rolling the second radiation element can be prevented. When the lateral width of the second radiation element is 0.5λ₀ or less, it can be prevented that the antenna becomes large. Accordingly, a small antenna having a wide band can be made by the invention.

In the wide band antenna according to the invention, it is preferable that the second radiation element is bent or rolled to two or more layers, an interlayer shortest distance is 0.005λ₀ or more, and an interlayer longest distance is 0.12λ₀ or less.

When an interlayer distance is less than 0.005λ₀, the wide band characteristics of an antenna may be lost by strong-coupling. Further, when the interlayer distance is 0.1λ₀ or less, the antenna can be made small. Accordingly, a small antenna having a wide band can be made by the invention.

In the wide band antenna according to the invention, it is preferable that the shape of the second radiation element in a section orthogonal to the first straight line is a spiral shape, a planar spiral shape, a part of a circular shape, or a meander shape or a combination of these shapes.

The wide band antenna according to the invention can be formed in a shape suitable for mounting while keeping input characteristics and radiation characteristics by the invention.

In the wide band antenna according to the invention, it is preferable that the second radiation element includes metal films laminated on a dielectric sheet.

When the second radiation element is composed of a metal film having a dielectric sheet laminated on one side or each of both sides thereof, the wide band antenna according to the invention can be easily manufactured.

In the wide band antenna according to the invention, it is preferable that the second radiation element includes a dielectric block inserted between the metal films.

When a second radiation element is composed of a dielectric block inserted between metal films, the wide band antenna according to the invention can be easily manufactured.

In the wide band antenna according to the invention, it is preferable that a power supply point of the second radiation element is disposed to an end in a direction approximately orthogonal to the disposition direction of the second radiation element and the first radiation element.

When a second radiation element is bent or rolled, a power supply point can be disposed inside as well as outside the second radiation element by the invention. When the power supply point is disposed inside the second radiation element, a radiation performed by a power supply cable can be suppressed. With the configuration, the characteristics of the antenna can be improved. In contrast, when the power supply point is disposed outside the second radiation element, the power supply cable can be connected after the second radiation element is bent or rolled. With the configuration, the antenna can be easily manufactured and inspected.

### Effect of the Invention

According to the invention, an antenna, which is small and can cope with the wide band as well as has radiation characteristics stable throughout the wide band, can be provided.

### BRIEF DESCRIPTION OF THE DRAWINGS

FIG. 1 is a schematic view of a configuration of a wide band antenna according to an embodiment 1.

FIG. 2 is a schematic view of a configuration of the wide band antenna according to the embodiment 1 in a state that the antenna is spread.

FIG. 3A shows an example in which a power supply cable is disposed outside a folded substrate.

FIG. 3B shows an example in which the power supply cable is disposed inside the folded substrate.

FIG. 4A shows an example in which the power supply cable is disposed outside the substrate rolled in a cylindrical shape.

FIG. 4B shows an example in which the power supply cable is disposed inside the substrate rolled in the cylindrical shape.

FIG. 5 is a pick-up view of a mode of a second radiation element and a first radiation element.

FIG. 6 shows a result of measurement of the directionality of the wide band antenna according to the embodiment 1.

FIG. 7A shows a planar shape.

FIG. 7B shows a spiral shape.

FIG. 7C shows a planar spiral shape.

FIG. 7D shows a circular roll shape.

FIG. 7E shows a meander shape.

FIG. 8A shows a planar shape.

FIG. 8B shows a spiral shape.

FIG. 8C shows a planar spiral shape.

FIG. 8D shows a circular roll shape.

FIG. 8E shows a meander shape.

FIG. 9A shows a combination of the meander shape and the spiral shape.

FIG. 9B shows a combination of the meander shape and the circular roll shape.

FIG. 10 shows an example of currents flowing on the antenna.

FIG. 11 shows a schematic view of a radiation at an observation point P.

FIG. 12A shows an antenna pattern when the second radiation element is of a glass shape.

FIG. 12 B shows a case that the second radiation element is of an elliptical shape.

FIG. 12C shows a case that the second radiation element is of a trapezoid shape.

FIG. 12D shows a case that the second radiation element is of a semielliptical shape.

FIG. 12E shows a case that the second radiation element and the first radiation element are of the same shape.

FIG. 12F shows a case that the second radiation element and the first radiation element are of a similar shape.

FIG. 13A shows a first application example to a dipole antenna.

FIG. 13B shows a second application example to the dipole antenna.

FIG. 13C shows an application example to a monopole antenna.

FIG. 14 shows an antenna pattern of a wide band antenna according to an embodiment 3.

FIG. 15A shows an antenna pattern when the second radiation element is of a glass shape.

FIG. 15B shows an antenna pattern when the second radiation element is of a square shape.

FIG. 16 shows input characteristics when the second radiation element is of the glass shape and when the second radiation element is of the square shape.

FIG. 17A shows an antenna pattern when the second radiation element is of the glass shape.

FIG. 17B shows an antenna pattern when the second radiation element is of an elliptical shape.

FIG. 18 shows input characteristics when the second radiation element is of the glass shape and when the second radiation element is of the elliptical shape.

FIG. 19A shows a schematic view of the antenna when the antenna has the hole.

FIG. 19B shows a schematic view of the antenna when the antenna does not have the hole.

FIG. 20 shows input characteristics when the wide band antenna according to the embodiment 3 has the elliptical hole and when it does not have the elliptical hole.

FIG. 21 shows a schematic view of the wide band antenna according to the embodiment 3 when the width W_{2c} of a convex portion in the antenna is changed.

FIG. 22 shows input characteristics when the width W_{2c} of the convex portion in the wide band antenna according to the embodiment 3 is changed.

FIG. 23 shows radiation patterns on an xy surface of the wide band antenna according to the embodiment 3.

FIG. 24A shows an antenna pattern in a planar shape.

FIG. 24B shows a state that the second radiation element is rolled in a spiral shape.

FIG. 24C shows the second radiation element rolled in the spiral shape when the radiation element is viewed thereabove.

FIG. 25 shows input characteristics of the wide band antenna according to the embodiment 3 when a space between spiral layers is changed.

FIG. 26 shows a radiation pattern on the xy surface of the wide band antenna according to the embodiment 3 at 8 GHz.

FIG. 27A shows an antenna pattern in a planar shape.

FIG. 27B shows a state that a second radiation element is rolled in a planar spiral shape.

FIG. 27C shows a state that the second radiation element rolled in the planar spiral shape is viewed from thereabove.

FIG. 28 shows input characteristics of the wide band antenna according to the embodiment 4 when spaces between planar spiral layers are changed.

FIG. 29 shows a radiation pattern on an xv surface of the wide band antenna according to the embodiment 4 at 8 GHz.

FIG. 30A shows an antenna pattern in a planar shape.

FIG. 30B shows a state that a second radiation element is bent in a meander shape.

FIG. 30 C shows a state when the second radiation element bent in the meander shape is viewed from thereabove.

FIG. 31 shows input characteristics of the wide band antenna according to the embodiment 5 when a space sm between meander layers are changed.

FIG. 32 shows a radiation pattern on an xy surface of the wide band antenna according to the embodiment 5 at 8 GHz.

FIG. 33A shows an antenna pattern in a planar shape.

FIG. 33B shows a state that a second radiation element is rolled in a circular roll shape.

FIG. 33C shows a state that the second radiation element rolled in the circular roll shape is viewed from thereabove.

FIG. 34 shows input characteristics of the wide band antenna according to the embodiment 6 when the diameter of the circular roll is set to dc=8 mm.

FIG. 35 shows a radiation pattern on an xy surface of the wide band antenna according to the embodiment 6 at 8 GHz.

FIG. 36 shows an antenna pattern of a wide band antenna according to an embodiment 7.

FIG. 37A shows an antenna pattern in a planar shape.

FIG. 37B shows a state that an second radiation element is rolled in a spiral shape.

FIG. 37C shows the second radiation element rolled in the spiral shape when the second radiation element is viewed from thereabove.

FIG. 38 shows input characteristics of the wide band antenna according to the embodiment 7 when a space ds between spiral layers is set to 10 mm.

FIG. 39 shows a radiation pattern on an xy surface of the wide band antenna according to the embodiment 7 at 8 GHz.

FIG. 40A shows a case that a power supply point is disposed inside a first radiation element.

FIG. 40B shows a case that the power supply point is disposed outside the first radiation element.

### DETAILED DESCRIPTION OF THE INVENTION

Embodiments of the invention will be explained referring to the accompanying drawings. The embodiments explained below are examples of a configuration of the invention, and the invention is by no means restricted by the embodiments.

### Embodiment 1

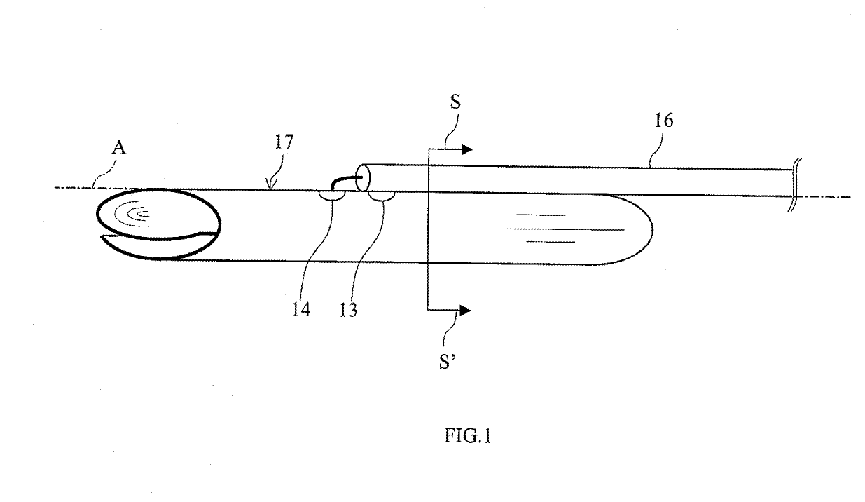

FIG. 1 is a schematic view of a configuration of a wide band antenna according to an embodiment 1. The wide band antenna according to the embodiment is a wide band antenna in which a second radiation element and a first radiation element are disposed on the same substrate 17 and has a feature in that the substrate 17 is bent on a straight line which is approximately parallel with a first straight line A for connecting a power supply point 14 of the second radiation element to a power supply point 13 of the first radiation element or rolled in a cylindrical shape using a straight line approximately parallel with the first straight line A as its axis direction. Then, a power supply cable 16 is disposed in parallel with the first straight line A. Here, the first straight line A is approximately parallel with a disposition direction in which the second radiation element and the first radiation element are disposed.

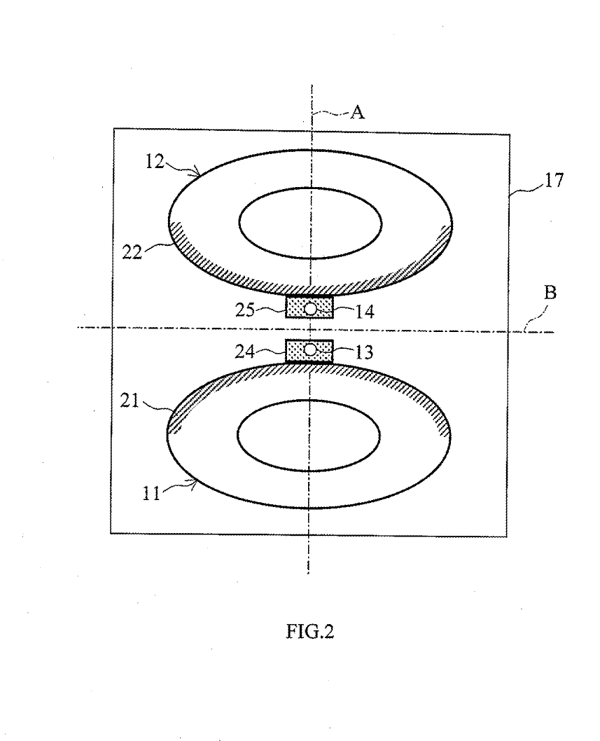

FIG. 2 is a schematic view of a configuration of the wide band antenna according to the embodiment in a state that the antenna is spread. The wide band antenna according to the embodiment includes a first radiation element 11, a second radiation element 12, the power supply point 13 to the first radiation element 11, the power supply point 14 to the second radiation element 12, a first convex portion 24, and a second convex portion 25. The second radiation element 12 and the first radiation element 11 have a proximity portion where they confront each other. In the embodiment, the proximity portion is configured by causing a part 22 of the outer periphery of the second radiation element 12 to confront a part 21 of the outer periphery of the first radiation element 11. An external conductor of the power supply cable is connected to a terminal of the power supply point 13 of the first radiation element 11. An internal conductor of the power supply cable is connected to a terminal of the power supply point 14 of the second radiation element 12.

In the wide band antenna according to the embodiment, the second radiation element 12 and the first radiation element 11 are disposed on the same surface. For example, the second radiation element 12 and the first radiation element 11 are formed on the common substrate 17. Although a substrate material may be an insulator such as polyimide and the like, it may be a dielectric such as an epoxy resin, an acryl resin, and the like. The wide band antenna according to the embodiment can be made small while obtaining good VSWR characteristics even if the substrate material is composed of the insulator. When the substrate material is composed of the dielectric, the wide band antenna can be made smaller. To set and fix the positional relation between the second radiation element 12 and the first radiation element 11, the second radiation element 12 and the first radiation element 11 may be bonded on a dielectric substrate material such as an FR-4 print substrate, an acryl resin and the like by an adhesive substance. The radiation elements are formed of a conductive thin film such as a metal film and the like.

The shapes of the outer peripheries of the second radiation element 12 and the first radiation element 11 are preferably line-symmetrical to the first straight line A. For example, when the shapes of the outer peripheries of the second radiation element 12 and the first radiation element 11 are ellipses, the short axes of the ellipses are disposed on the first straight line A. The shapes of the outer peripheries of the second radiation element 12 and the first radiation element 11 are not limited to the ellipses and may be circles, ellipses, polygons and combinations thereof. In the case, the center points of the shapes of the outer peripheries of the second radiation element 12 and the first radiation element 11 are disposed on the first straight line A. The second radiation element 12 and the first radiation element 11 are preferably nearest to each other on the first straight line A.

The power supply points 13 and 14 are preferably disposed on the first straight line A. With the configuration, power can be supplied to a position where the second radiation element 12 and the first radiation element 11 are nearest to each other. The power supply points 13 and 14 are preferably disposed at positions having the same distance from a second straight line B. The distance between the power supply point 13 and the power supply point 14 is preferably 0.2 mm or more and further preferably about 0.35 mm.

The first convex portion 24 is a portion in which a part of the outer periphery of the first radiation element 11 is formed in a convex shape. The second convex portion 25 is a portion in which a part of the outer periphery of the second radiation element 12 is formed in a convex shape. The first convex portion 24 and the second convex portion 25 are disposed to the proximity portion where the second radiation element 12 confronts the first radiation element 11 so as to confront each other. The first convex portion 24 and the second convex portion 25 are preferably disposed to portions where the second radiation element 12 and the first radiation element 11 are nearest to each other in the outer peripheries of the second radiation element 12 and the first radiation element 11. Further, the first convex portion 24 and the second convex portion 25 are preferably disposed on the first straight line A which traverses the centers of the second radiation element 12 and the first radiation element 11.

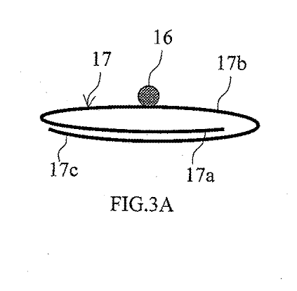

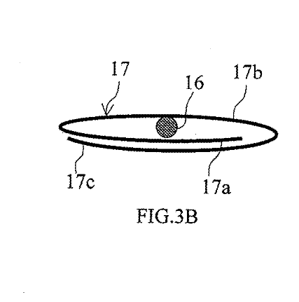

FIG. 3A and FIG. 3B shows a first example of an S-S′ sectional view shown in FIG. 1, wherein FIG. 3A shows an example in which a power supply cable is disposed outside a folded substrate, and FIG. 3B shows an example in which the power supply cable is disposed inside the folded substrate. The S-S′ sectional view shows a sectional view passing through S-S′ shown in FIG. 1 as well as on a section orthogonal to the first straight line A. The first example of the S-S′ sectional view is bent on a straight line approximately parallel with the first straight line A shown in FIG. 1 and FIG. 2. Even when the second radiation element 12 and the first radiation element 11 shown in FIG. 2 are disposed on bent substrates 17a, 17b, and 17c, the non-directionality of the wide band antenna can be improved.

As shown in FIG. 3A, when the power supply cable 16 is disposed outside the folded substrate, the thickness of the folded substrates 17b, 17a, and 17c can be reduced. In contrast, as shown in FIG. 3B, when the power supply cable 16 is disposed inside the folded substrate, since a convex portion can be eliminated from the power supply cable 16, the wide band antenna can be easily mounted on information terminal equipment.

In the wide band antenna shown in FIG. 3A and FIG. 3B, the bent substrates 17b, 17a, and 17c are bent so as to be sequentially overlapped to three sheets. Here, the number of overlapped sheets in the wide band antenna according to the embodiment is not limited. For example, the number of the overlapped sheets is preferably an odd number such as three sheets, five sheets, seven sheets, and the like. In the case, the creases of the respective bent substrates are preferably line-symmetrical straight lines using the first straight line A as their center lines.

In the wide band antenna according to the embodiment, the substrate 17a which is bent and disposed inside is preferably not in contact with the substrate 17b adjacent to the substrate 17a from a view point of improvement of non-directionality. Accordingly, as shown in FIG. 3B, the power supply cable 16 is preferably disposed inside the folded substrates 17a, 17b.

Note that the second radiation element and the first radiation element shown in FIG. 2 may be disposed on a bent inside surface or may be disposed on a bent outside surface. A through hole may be defined to the substrate 17, and the power supply cable 16 may be disposed on a surface opposite to a surface on which the second radiation element and the first radiation element are disposed.

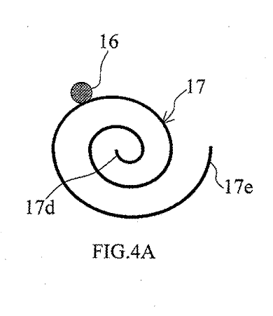

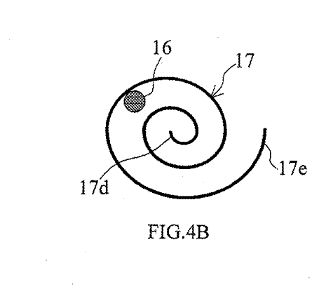

FIG. 4A and FIG. 4B shows a second example of the S-S′ sectional view shown in FIG. 1 wherein FIG. 4A shows an example in which the power supply cable is disposed outside the substrate rolled in a cylindrical shape and FIG. 4B shows an example in which the power supply cable is disposed inside the substrate rolled in the cylindrical shape. The second example of the S-S′ sectional view is rolled in the cylindrical shape using a straight line approximately parallel with the first straight line A shown in FIG. 1 and FIG. 2 as its axis direction. Even when the second radiation element 12 and the first radiation element 11 shown in FIG. 2 are disposed on a substrate 17d disposed on the axis side of the cylinder and on a substrate 17e disposed on the outer periphery side of the cylinder, the non-directionality of the wide band antenna can be improved.

As shown in FIG. 4A, when the power supply cable 16 is disposed on a rolled outside, the outside diameter of the rolled substrate 17 can be reduced. In contrast, as shown in FIG. 4B, when the power supply cable 16 is disposed on a rolled inside, since a convex portion can be eliminated from the power supply cable 16, the wide band antenna can be easily mounted on the information terminal equipment.

In the wide band antenna shown in FIG. 4A and FIG. 4B, the substrate 17 is rolled 2.5 times. Here, in the wide band antenna according to the embodiment, the number of times the substrate 17 is rolled is not limited. The number of times may be, for example, less than once at which the substrate 17d disposed on the axis side of the cylinder is not overlapped with the substrate 17e disposed on the outer periphery side of the cylinder. Further, the number of times the substrate 17 is rolled may be three times or more in addition to once, 1.5 times, twice, and 2.5 times. Further, the substrate 17 can be rolled until the outside diameter of the rolled substrate 17 becomes approximately as small as the outside diameter of the power supply cable 16. With the configuration, a chip on which the antenna is mounted is not necessary as well as the wide band antenna can be mounted on the information terminal equipment by being wound around various cables such as LAN (Local Area Network) cable and the like. Further, when the wide band antenna is wound around a dielectric, non-directionality can be improved as well as the wide band antenna can be made small.

Note that the second radiation element and the first radiation element shown in FIG. 2 may be disposed on a rolled inside surface and may be disposed on a rolled outside surface likewise the first example of the S-S′ sectional view shown in FIG. 3A and FIG. 3B. A through hole may be defined to the substrate 17, and the power supply cable 16 may be disposed on a surface opposite to a surface on which the second radiation element and the first radiation element are disposed.

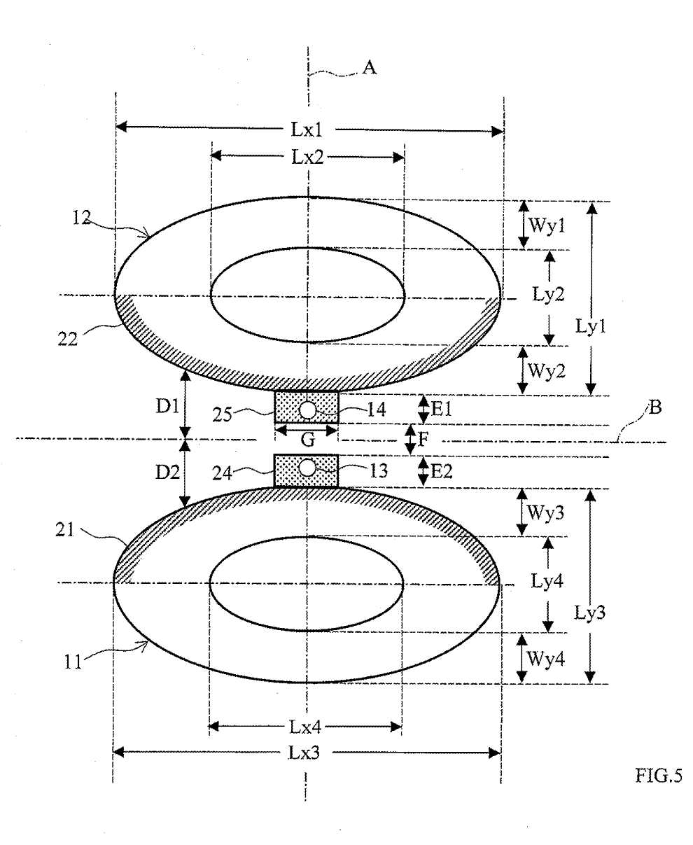

FIG. 5 is a pick-up view of the second radiation element and the first radiation element.

Lx1 shows a long diameter of the outer periphery of the second radiation element 12, Ly1 shows a short diameter of the outer periphery of the second radiation element 12, Lx2 shows a long diameter of the inner periphery of the second radiation element 12, Ly2 shows a short diameter of the inner periphery of the second radiation element 12, Lx3 shows a long diameter of the outer periphery of the first radiation element 11, Ly3 shows a short diameter of the outer periphery of the first radiation element 11, Lx4 shows a long diameter of the inner periphery of the first radiation element 11, and Ly4 shows a short diameter of the inner periphery of the first radiation element 11.

Wy1 shows a width from the inner periphery to the outer periphery of the second radiation element 12 on a side far from the second straight line B, Wy2 shows a width from the inner periphery to the outer periphery of the second radiation element 12 on a side near to the second straight line B, Wy3 shows a width from the inner periphery to the outer periphery of the first radiation element 11 on a side near to the second straight line B, and Wy4 shows a width from the inner periphery to the outer periphery of the first radiation element 11 on a side far from the second straight line B.

D1 shows a distance between the second straight line B and a part 22 of the outer periphery of the second radiation element 12, and D2 shows a distance between the second straight line B and a part 21 of the outer periphery of the first radiation element 11.

The second radiation element 12 is preferably of a loop shape. For example, the second radiation element 12 has such a structure that a conductor in a center portion is removed. The shape of an inner peripheral portion from which the conductor is removed may be formed in any arbitrary shape, for example, a circle, an ellipse, a polygon having sides as many as or more than a triangle, a combination thereof, and the like. The first radiation element 11 is also preferably of a loop shape likewise the second radiation element 12.

Note that the first radiation element 11 and the second radiation element 12 may be formed with loops. For example, the first radiation element 11 and the second radiation element 12 may be formed in such a shape that a strip-shaped conductor is disposed on the long axis of the inner periphery of any one of or each of both of the first radiation element 11 and the second radiation element 12. Further, the first radiation element 11 and the second radiation element 12 may be formed in such a shape that the second radiation element 12 and the first radiation element 11 are cut off in a short axis direction and released ends are connected by a strip-shaped conductor. As described above, the shapes of outer peripheries of the second radiation element 12 and the first radiation element 11 can be formed in any arbitrary shape except the proximity portion. In particular, the wide band antenna can be made small by bridging the end portions of the proximity portion via a strip-shaped conductor.

The shape of the part 22 of the outer periphery of the second radiation element 12 is preferably line-symmetrical to the shape of the part 21 of the outer periphery of the first radiation element 11 with respect to the second straight line B. For example, the distance DI is equal to the distance D2 on a straight line parallel with the first straight line A.

The part 22 of outer periphery of the second radiation element 12 and the part 21 of the outer periphery of the first radiation element 11 preferably have curved shapes which permit the second radiation element 12 to be located nearest to the first radiation element 11 on the first straight line A. In particular, the shape of the part 22 of the outer periphery of the second radiation element 12 and the shape of the part 21 of the outer periphery of the first radiation element 11 are preferably parts of ellipses. In the case, the short axes of the ellipses are disposed on the first straight line A.

The distance (D1+D2) between the second radiation element 12 and the first radiation element 11 on the first straight line A in which the second radiation element 12 is nearest to the first radiation element 11 is preferably 0.2 mm or more and further preferably approximately 0.35 mm.

The outer peripheral shape and the inner peripheral shape of the second radiation element 12 are preferably ellipses having short axes disposed on the first straight line A. In the case, the long diameter of the outer periphery of the second radiation element 12 is preferably 14 mm or more to 40 mm or less. Further, the ratios of the long diameters and the short diameters Lx1:Ly1 and Lx2:Ly2 are preferably 1:0.3 or more to 1:0.7 or less. In particular, the ratios of the long diameters and the short diameters are preferably 2:1, and when Lx1 is 40 mm, it is preferable that Ly1 is 20 mm, Lx2 is 20 mm, and Ly2 is 10 mm.

The shape of the outer periphery and the shape of the inner periphery of the second radiation element 12 are preferably ellipses having the same ratio of long diameters and short diameters, i.e, the same ellipse ratio. The shapes have, for example, the relation of Lx1/Ly1=Lx2/Ly2. The first radiation element 11 is also the same as above and it is preferable that the first radiation element 11 has the relation of Lx3/Ly3=Lx4/Ly4.

The long diameter of the inner periphery of the second radiation element 12 is preferably equal to the short diameter of the outer periphery of the second radiation element 12. The second radiation element 12 has, for example, the relation of Ly1=Lx2. The first radiation element 11 is the same as the second radiation element 12, and, in the case, the first radiation element 11 has the relation of Ly3=Lx4.

The shape and the area of the second radiation element 12 are preferably the same as those of the first radiation element 11. In particular, the shapes of the outer periphery and the inner periphery of the second radiation element 12 and the shapes of the outer periphery and the inner periphery of the first radiation element 11 are preferably ellipses having the same ellipse ratio. In the case, the second radiation element 12 and the first radiation element 11 have the relation of Lx1/Ly1=Lx2/Ly2=Lx3/Ly3=Lx4/Ly4 as well as Wy2=Wy3, Wy1=Wy4.

The widths from the inner peripheries to the outer peripheries of the second radiation element 12 and the first radiation element 11 are preferably thicker on a side far from the second straight line B than a side near thereto. The second radiation element 12 and the first radiation element 11 have, for example, the relation of Wy1>Wy2, Wy3<Wy4.

Edges where the first convex portion 24 confronts the second convex portion 25 are parallel with each other. The shapes of the edges where the first convex portion 24 confronts the second convex portion 25 may be straight lines or curved lines. The shapes of edges where the first convex portion 24 confronts the second convex portion 25 are, for example, straight lines parallel with the second straight line B. Here, the second straight line B is a straight line which is orthogonal to the first straight line A and passes through the center between the second radiation element 12 and the first radiation element 11. That is, the second straight line B faces a direction orthogonal to a direction where the second radiation element 12 confronts the first radiation element 11. Accordingly, the shapes of the first convex portion 24 and the second convex portion 25 are preferably parts of polygons having the even number of sides equal to or more than 4 sides. In the case, a center line passing through a side of each polygon having the even number of sides is preferably disposed on the first straight line A.

The first convex portion 24 and the second convex portion 25 are preferably formed in loop shapes. When the first convex portion 24 and the second convex portion 25 are formed in the loop shapes, the non-directionality of the antenna is improved. In the case, the power supply points 13 and 14 are disposed to the second straight line B side with respect to the loops. With the configuration, an abrupt increase of impedance from the power supply cable to the power supply points 13 and 14 can be suppressed.

In an UWB antenna, the widths G of the first convex portion 24 and the second convex portion 25 in a direction parallel with the second straight line B are preferably 3 mm or more to 12 mm or less. Note that, when the wide band antenna is used to a wavelength band of a wireless LAN, a mobile phone, and the like, even if the widths G are set to about 40 mm, the effect of the invention can be achieved. Here, the widths G are widths of the portions with which the first convex portion 24 and the second convex portion 25 are confronted in parallel.

A space F between the first convex portion 24 and the second convex portion 25 is preferably 0.2 mm or more to 2 mm or less. When the distance between outside edges of the first convex portion 24 and the second convex portion 25 are appropriately set, the non-directionality of the antenna is improved. When the shapes of the outside edges of the first convex portion 24 and the second convex portion 25 are curved or bent, it is preferable that the distance between the first convex portion 24 and the second convex portion 25 in a portion where the first convex portion 24 is nearest to the second convex portion 25 keeps 0.2 mm or more to 2 mm or less.

The directionality of the wide band antenna shown in FIG. 4 A was measured. An example 1 shows a case that the substrate 17 was rolled once, an example 2 shows a case that the substrate 17 was rolled 1.5 times, an example 3 shows a case that the substrate 17 was rolled 2.5 times. Parameters shown in FIG. 5 as to the examples 1, 2 and 3 are G=3.2 mm, E1=E2=0.9 mm, F=0.2 mm, Lx1=Lx3=40 mm, Ly1=Ly3=Lx2=Lx4=20 mm, and Ly2=Ly4=10 mm. A PET (polyethylene terephthalate) film was used as the substrate.

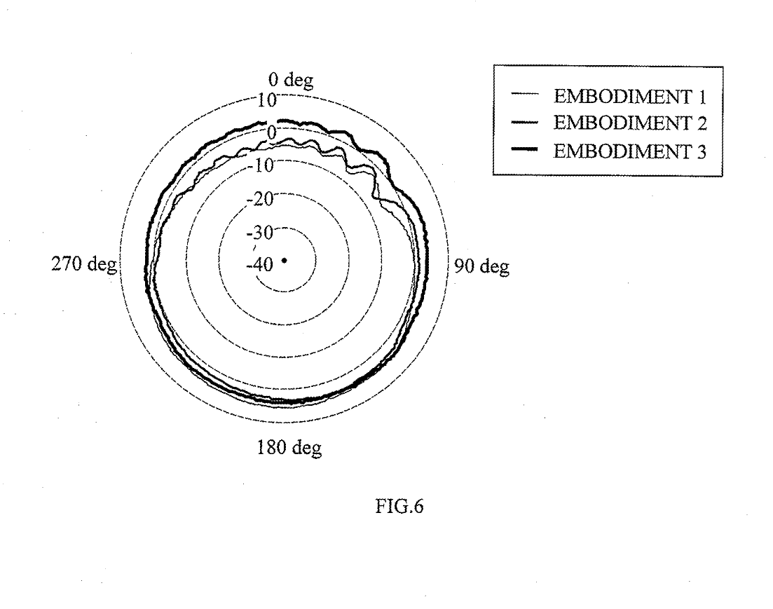

FIG. 6 shows a result of measurement of the directionality of the wide band antennas according to the embodiment. As the substrate was rolled more times as shown in the example 1, the example 2, and the example 3, the non-directionality of the wide band antenna was more improved. When the substrate was bent, the non-directionality of the wide band antenna was improved likewise by bending the substrate. Accordingly, the non-directionality could be improved by bending or cylindrically rolling the wide band antenna in which the second radiation element and the first radiation element were formed on the same surface.

### Embodiment 2

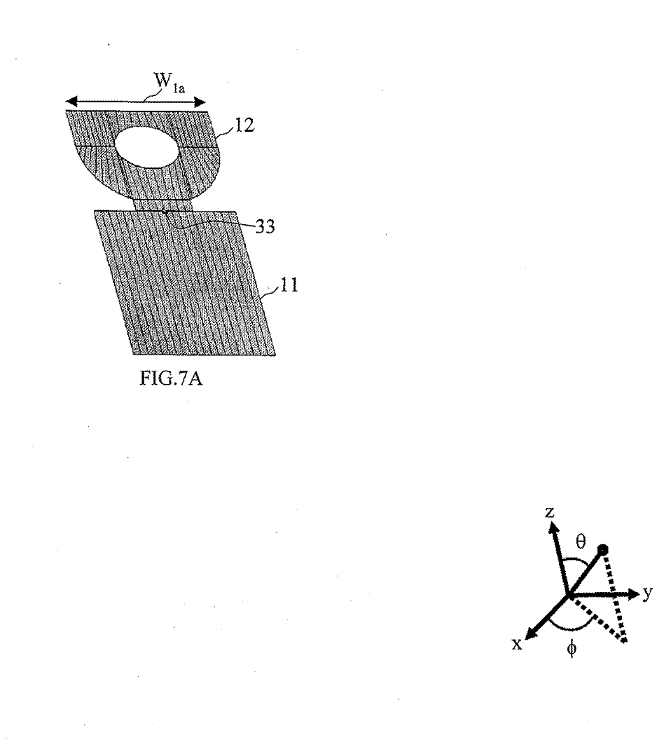

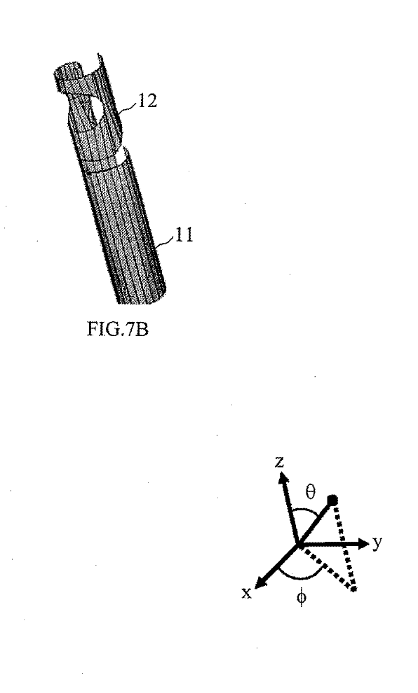

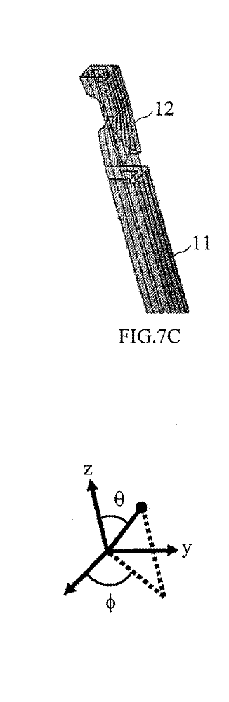

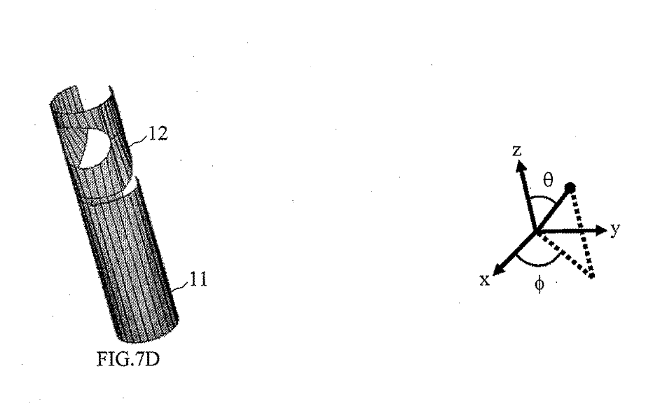

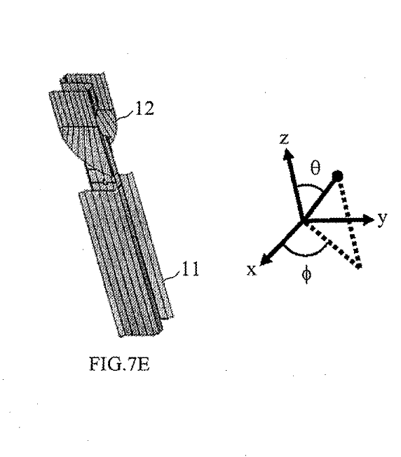

FIG. 7A, FIG. 7B, FIG. 7C, FIG. 7D and FIG. 7E shows an example of the shape of a wide band antenna according to the embodiment. The wide band antenna according to the embodiment includes a first radiation element 11 connected to an external conductor of a power supply cable and supplied with high frequency power, a second radiation element 12 connected to an internal conductor of the power supply cable and supplied with high-frequency power, and a power supply point 33 to the second radiation element 12 and the first radiation element 11. The second radiation element 12 and the first radiation element 11 are disposed approximately in parallel with a z-axis. The internal conductor of the power supply cable is connected to a terminal of the power supply point 33 of the second radiation element 12. The external conductor of the power supply cable is connected to a terminal of the power supply point 33 of the first radiation element 11.

The second radiation element 12 has a feature in that it is bent on a straight line approximately parallel with the z-axis which is a first straight line approximately parallel with the disposition direction of the second radiation element 12 and the first radiation element 11 or it is rolled in a cylindrical shape using a straight line approximately parallel with the z-axis as the first straight line as its axis direction. For example, as shown in FIG. 7B, the second radiation element 12 is rolled in a spiral shape using the z-axis as its axis direction. Otherwise, as shown in FIG. 7C, the second radiation element 12 is rolled in a planar spiral shape using the z-axis as its axis direction. Otherwise, as shown in FIG. 7D, the second radiation element 12 is rolled in a circular roll shape using the z-axis as its axis direction. Otherwise, as shown in FIG. 7E, the second radiation element 12 is bent in a meander shape on a straight line approximately parallel with the z-axis.

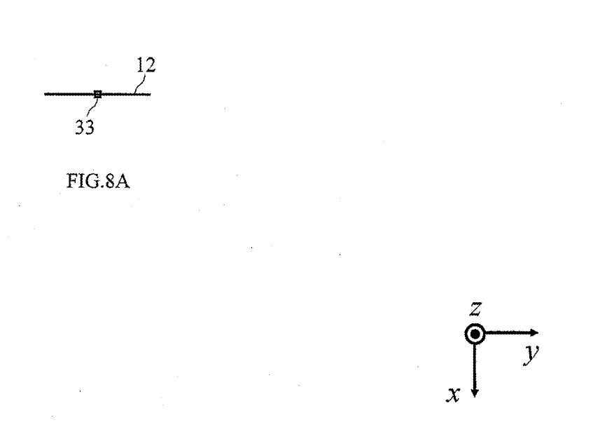

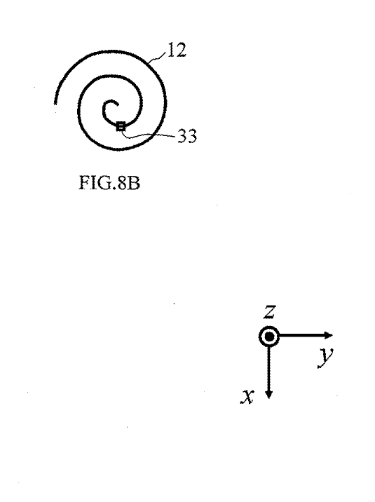

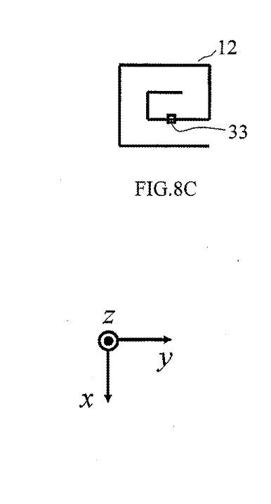

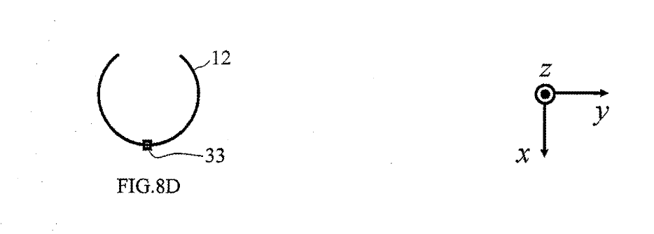

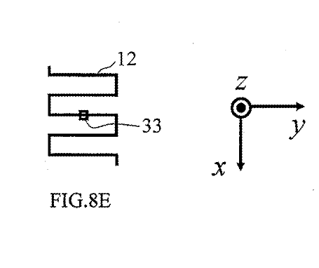

FIG. 8A, FIG. 8B, FIG. 8C, FIG. 8D and FIG. 8E shows an example of the shape of the wide band antenna according to the embodiment when it is viewed from thereabove, wherein FIG. 8A shows a planar shape, FIG. 8B shows a spiral shape, FIG. 8C shows a planar spiral shape, FIG. 8D shows a circular roll shape, and FIG. 8E shows a meander shape. The shape of the second radiation element 12 on a section orthogonal to the z-axis is, for example, the spiral shape as shown in FIG. 8B, the planar spiral shape as shown in FIG. 8C, a part of the circular shape as shown in FIG. 8D, or the meander shape as shown in FIG. 8E.

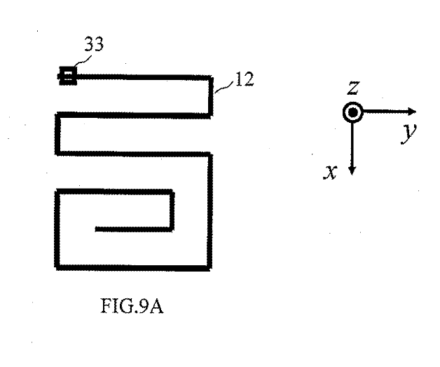

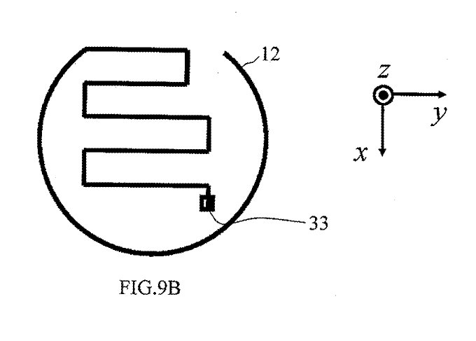

The shape of the second radiation element 12 on a section orthogonal to the z-axis may be the spiral shape, the planar spiral shape, a part of the circular shape, or a combination of the meander shape. For example, as shown in FIG. 9A, the shape of the second radiation element 12 may be a combination of the meander shape and the spiral shape. Further, as shown in FIG. 9B, the shape of the second radiation element 12 may be a combination of the meander shape and the circular roll shape.

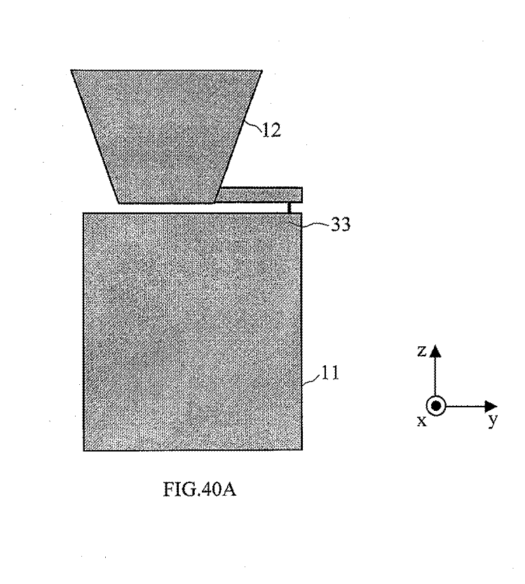

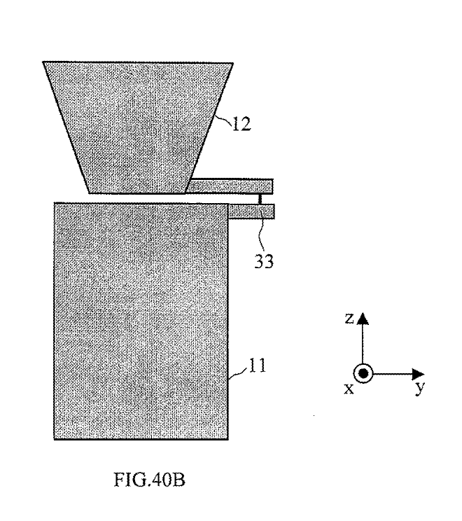

The second radiation element 12 is composed of a dielectric sheet on which metal films are laminated. For example, a substrate on which the second radiation element 12 is formed is composed of dielectric sheets clamped thereto. The second radiation element 12 may be composed of a dielectric block inserted between the metal films. Further, as shown in FIG. 40A and FIG. 40B to be described below, the power supply point 33 of the second radiation element 12 is preferably disposed to an end in a direction approximately orthogonal to the disposition direction of the second radiation element 12 and the first radiation element 11. In the case, as shown in FIG. 9A, the power supply point 33 of the second radiation element 12 can be disposed outside the second radiation element 12. Otherwise, as shown in FIG. 95, the power supply point 33 of the second radiation element 12 can be disposed inside the second radiation element 12.

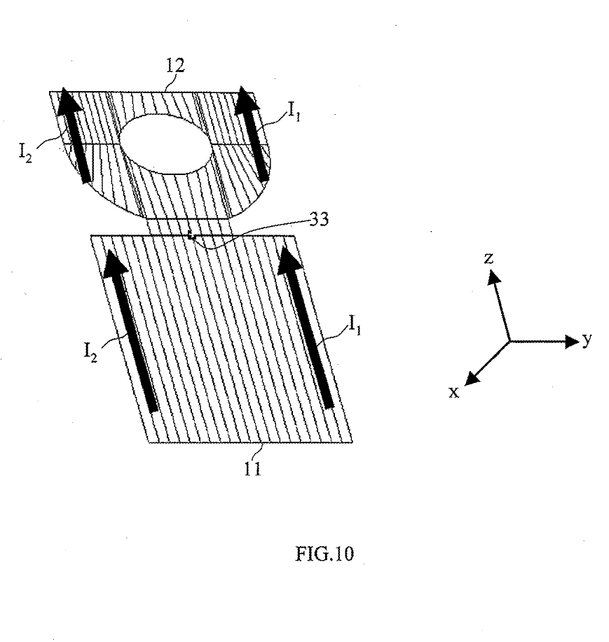

The wide band antenna to be proposed is designed such that, first, a planar film antenna performs a wide band operation in the planar shape. Although the planar antenna operates in a wide band by an optimization design, since a planar area is large, the planar antenna may not be installed on small wireless equipment. Further, ordinarily, the planar antenna has a large width in a y-direction of FIG. 7A, FIG. 7B, FIG. 7C, FIG. 7D or FIG. 7E. Since a current flowing on an antenna has a feature in that it is concentrated to an metal edge, a current I₁ and a current I₂, which flow in the vicinities of edges of the second radiation element 12 and the first radiation element 11 as shown in FIG. 10, may be considered as a main current source.

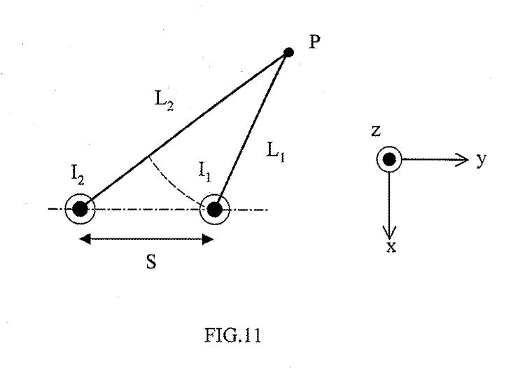

In the case, as shown in FIG. 11, a radiation at an observation point P is greatly changed depending on a relative position of the observation point P to the antenna. That is, when the point P is nearer to a y-axis direction, the difference between a distance L₁ from the current source and a distance L₂ from the current source I₂ becomes larger. As a result, when a distance S between the current sources becomes an order of wavelength, since a phase difference is caused in the contribution of the current sources I₁ and I₂ to radiation, circumstances which are disadvantageous to communication occur in that not only a radiation pattern in an xy surface becomes non-directional but also, when a pulse communication used in UWB is performed, a time difference occurs in a pulse that reaches the point P and a pulse width is increased, and the like. The influence becomes more prominent as a frequency being used becomes higher. In the circumstances, since the distance L₁ is equal to the distance L₂ in an x-direction and is different therefrom in a y-direction, a radiation gain in the y-direction is smaller than that in the x-direction.

In the proposal, the planar antenna is bent or rolled as shown in FIG. 7A, FIG. 7B, FIG. 7C, FIG. 7D and FIG. 7E. With the operation, not only the antenna is made compact and can be easily accommodated in the small wireless equipment but also the distance S between the edges of the antenna of FIG. 11 is reduced and thus the phase difference can be reduced. As a result, not only the radiation pattern of the antenna can be improved but also an influence on a pulse communication can be suppressed.

In contrast, when the planar antenna is bent, the respective portions of the antenna relatively approach to each other and coupling between the respective portions of the antenna becomes strong so that the input characteristics of the antenna may be deteriorated. The proposal can make the influence of the deterioration small by optimizing the characteristics of the planar antenna. That is, since the coupling mainly occurs in a region in which a wavelength is long (a frequency is low), when a matching is sufficiently performed particularly in a low frequency region at the time the planar antenna is optimized, the deterioration of the input characteristics caused when the antenna is bent can be suppressed to minimum.

Accordingly, a sufficient width is necessary to the planar antenna. When the width is increased, an operating frequency band is widened. Further, in the vicinity of the power supply point of one of or each of both of the radiation elements, a structure in which the width gradually increases from the power supply point toward an extreme end of the radiation element is necessary. In the structure, matching becomes better in a region in which the frequency is high. Further, in the vicinity of the power supply point, a region in which both the radiation elements confront is preferably large. Likewise, a band is widened. Further, a hole is preferably open so that any one of or both of the radiation elements are formed in the loop shape. Likewise, the band is widened.

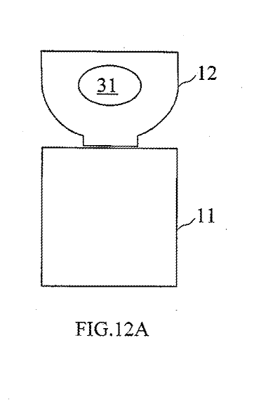

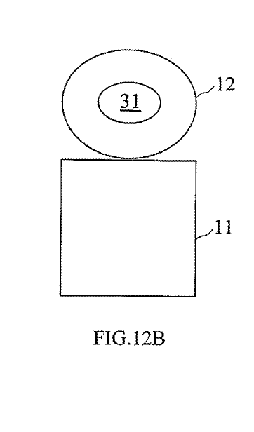

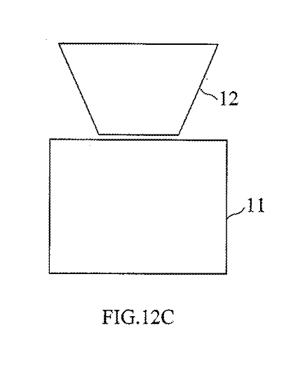

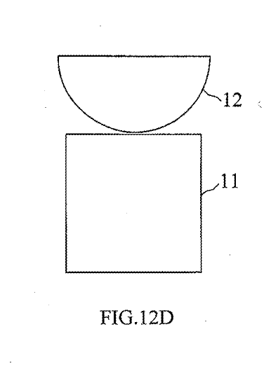

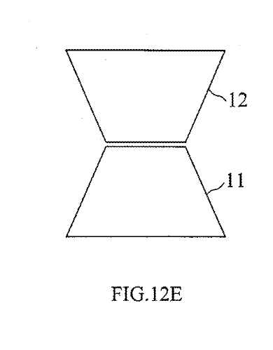

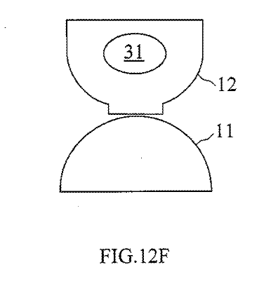

As shown in FIG. 12A, FIG. 12B, FIG. 12C, FIG. 12D, FIG. 12E and FIG. 12F, the planar antenna can use various shapes. The second radiation element 12 maybe of a glass shape as shown in FIG. 12A and FIG. 12F, maybe of an elliptical shape as shown in FIG. 12B, may be of a trapezoid shape as shown in FIG. 12C and FIG. 12E, and may be of a semielliptical shape as shown in FIG. 12D. Further, the shapes of the second radiation element 12 and the first radiation element 11 may be the same shape as shown in FIG. 12E, may be a similar shape as shown in FIG. 12F, and may be of different shapes as shown in FIG. 12A, FIG. 12B, FIG. 12C, and FIG. 12D. The lateral width of the second radiation element 12 is not necessarily the same as that of the first radiation element 11 and may be different as shown in, for example, FIG. 12C.

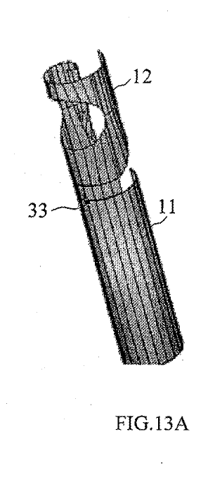

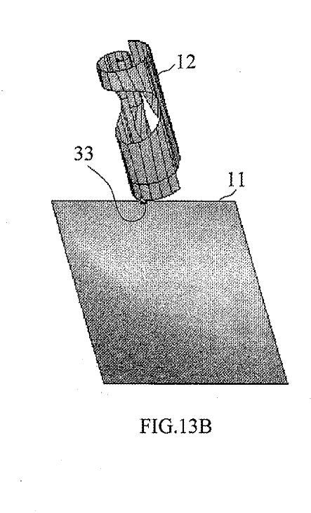

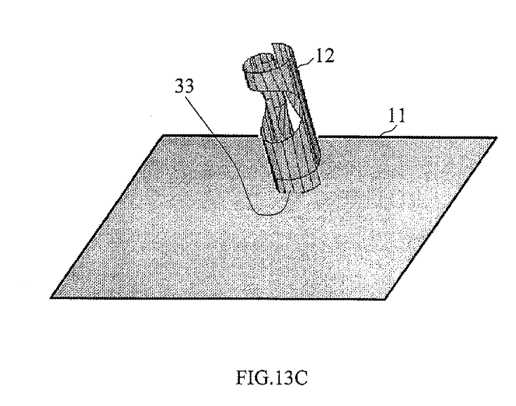

The wide band antenna according to the embodiment can be applied not only to a dipole antenna but also to a monopole antenna. FIG. 13A, FIG. 13B and FIG. 13C shows application examples of the wide band antenna according to the embodiment, wherein FIG. 13A shows a first application example to the dipole antenna, FIG. 13B shows a second application example to the dipole antenna, and FIG. 13C shows an application example to the monopole antenna. In the dipole antenna, there are a case that both the second radiation element 12 and the first radiation element 11 are bent or rolled as shown in FIG. 13A and a case that only the second radiation element 12 is bent or rolled as shown in FIG. 13B. In the monopole antenna, only the second radiation element 12 is bent or rolled as shown in FIG. 13C.

### Embodiment 3

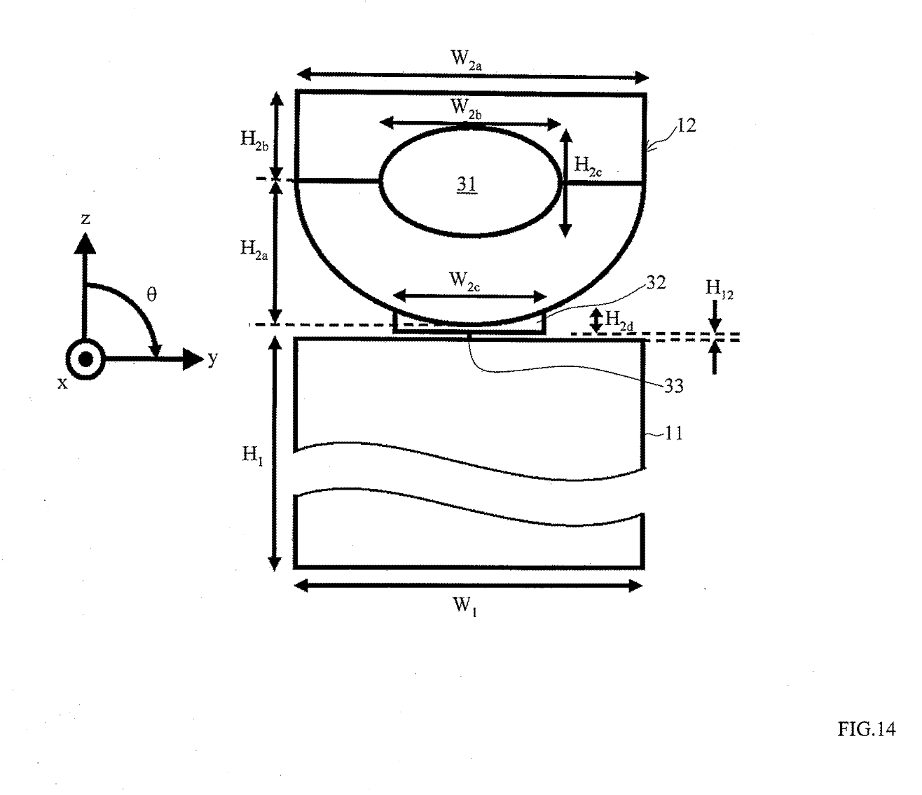

FIG. 14 shows an antenna pattern of a wide band antenna according to the embodiment. The wide band antenna according to the embodiment is devised so that not only a band is simply wide but also a frequency is particularly matched well in a low frequency region. Specifically, a second radiation element 12 has an outside shape like a glass, an elliptical hole 31 is defined to form the second radiation element 12 in a loop shape, and an semielliptical outside shape and a trapezoidal convex portion 32 located near to a power supply point 33 are provided. The outside shape like the glass is formed such that as the distance between the second radiation element 12 and a first radiation element 11 increases, the width of the second radiation element 12 is increased from, for example, the position where the second radiation element 12 is nearest to the first radiation element 11 to the position of a predetermined height H₂ₐ in the disposition direction of the second radiation element 12 and the first radiation element 11.

In the embodiment, the second radiation element 12 has a width W₂ₐ=20 mm, a height H₂ₐ=8 mm, a height H_{2b}=5 mm, the second radiation element 12 has a height (H₂ₐ+H_{2b})=13 mm, the hole 31 has a width W_{2b}=9 mm, the hole 31 has a height H_{2c}=6 mm, the convex portion 32 has a width W_{2c}=8 mm, the convex portion 32 has a height H₂ₐ=1.6 mm, a space H₁₂=0.1 mm is set between the second radiation element 12 and the first radiation element 11, the first radiation element 11 has a width W₁=20 mm, and the first radiation element 11 has a height H₁=20 mm.

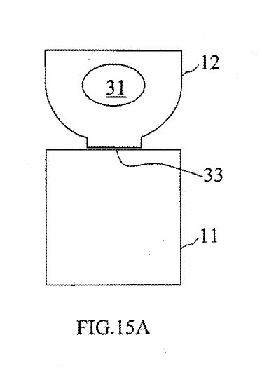

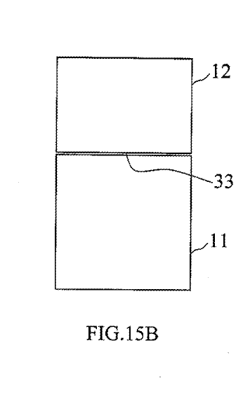

FIG. 15A and FIG. 15B shows a comparative example of the outside shape of the second radiation element, wherein FIG. 15A shows an antenna pattern when the second radiation element is of the glass shape and FIG. 15B shows an antenna pattern when the second radiation element is of a square shape. The second radiation element shown in FIG. 15A and the second radiation element shown in FIG. 15B have the same size with the same width and the same height.

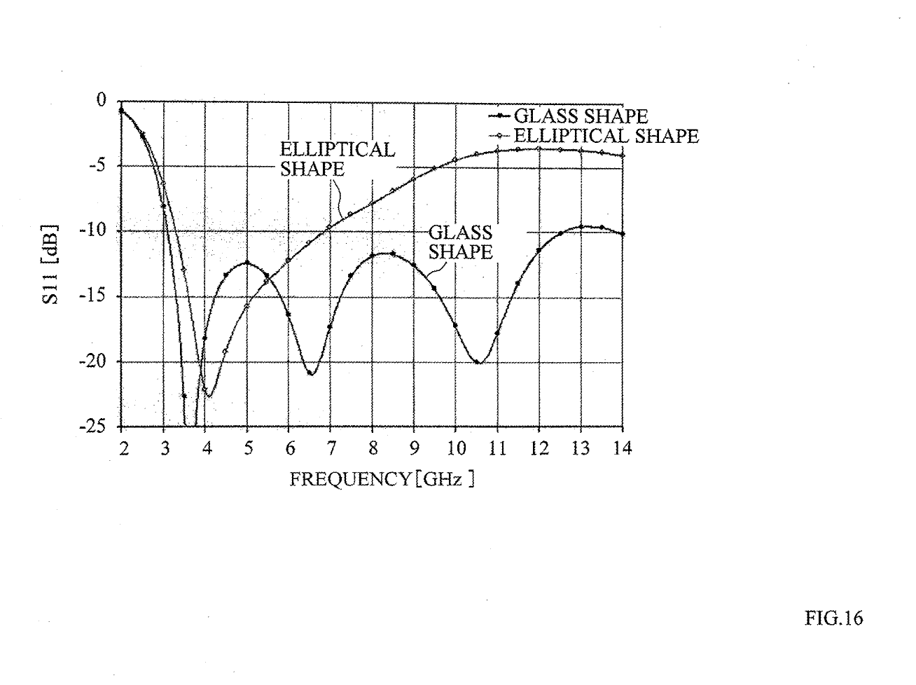

FIG. 16 shows input characteristics when the second radiation element is of the glass shape and when the second radiation element is of the square shape. As shown in FIG. 16, the glass-shaped wide band antenna according to the embodiment has a wide band in comparison with the square wide band antenna according to the comparative example and |S11| is −10 dB or less in the band of 3.1 GHz or more to 12.5 GHz or less. However, a characteristic impedance is set to 50Ω. |S11| in the following sentence uses also the value of the characteristic impedance as a reference. In particular, |S11| is set to −12 dB or less in a band of 3.1 GHz or more to 6.5 G Hz or less and matching becomes particularly good. Accordingly, when the antenna pattern of the second radiation element 12 is formed in the glass shape, the input characteristics can be improved in comparison with the case that the antenna pattern of the second radiation element is formed in the square shape.

The size of the antenna is such that when the wavelength of a minimum operating frequency is set to λ₀ (in the case, 97 mm), 0.25λ₀ or more is necessary as the sum of the longitudinal width (H₂ₐ+H_{2b}) and the lateral width W₂ₐ of at least one of both the radiation elements. Further, to secure a wide band, 0.1λ₀ or more is necessary as the lateral width W₂ₐ of the second radiation element 12. When an increase of the minimum operating frequency due to coupling caused when the second radiation element 12 is bent or rolled is taken into consideration, it is preferable that the sum of the longitudinal width (H₂ₐ+H_{2b}) and the lateral width W₂ₐ of the second radiation element 12 is 0.3λ₀ or more and that the lateral width W₂ₐ of the second radiation element 12 is 0.12λ₀ or more. Here, the lateral width W₂ₐ shows the width of a projected shape of the second radiation element 12 projected in the disposition direction of the second radiation element 12 and the first radiation element 11. Although a larger lateral width of the second radiation element 12 results in better characteristics, the width W₂ₐ of the second radiation element 12 is preferably set to 0.5λ₀ or less when practical usability of size is taken into consideration.

Further, when the second radiation element 12 is bent or rolled to two or more layers, if the space between nearest layers is excessively small, the wide band characteristics of the antenna are lost by strong-coupling. As shown in the following embodiment, an interlayer shortest distance is preferably 0.005λ₀ or more and preferably 0.01λ₀ or more in practical use. Further, from a viewpoint of miniaturization, an interlayer longest distance is preferably 0.1λ₀ or less.

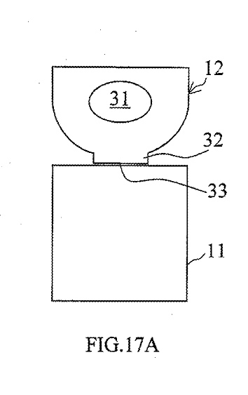

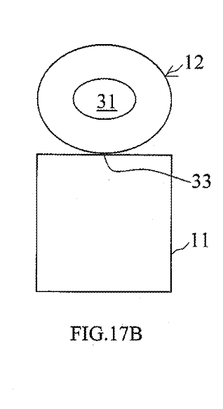

FIG. 17A and FIG. 17B shows a comparative example of the outside shape of the second radiation element, wherein FIG. 17A shows an antenna pattern when the second radiation element is of the glass shape and FIG. 17B shows an antenna pattern when the second radiation element is of an elliptical shape. The second radiation element shown in FIG. 17A and the second radiation element shown in FIG. 17B have the same size with the same width and the same height.

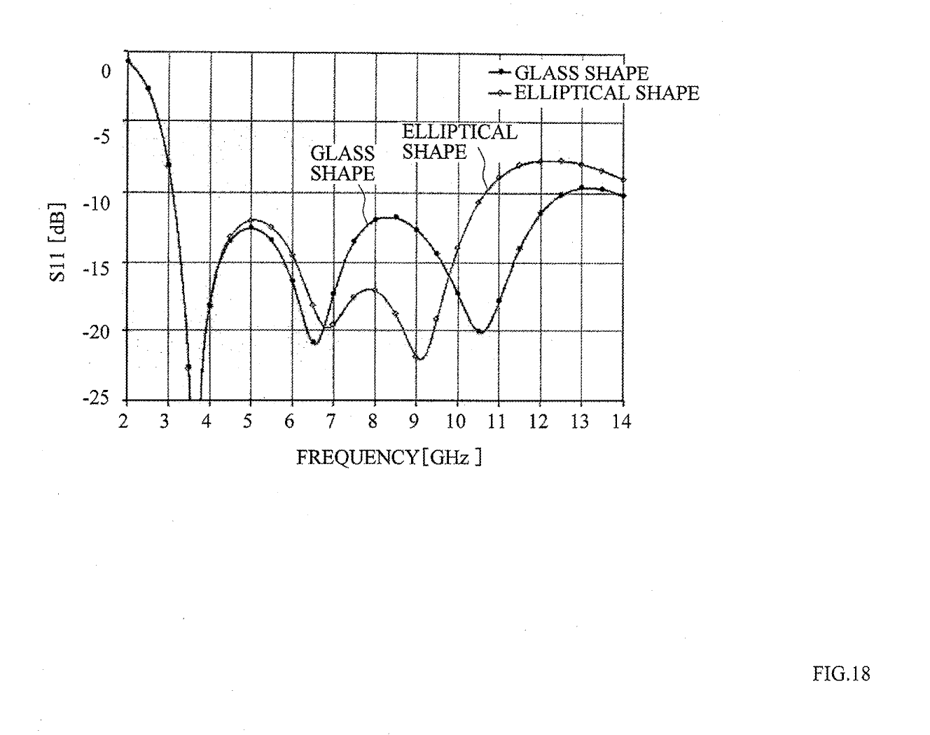

FIG. 18 shows input characteristics when the second radiation element is of the glass shape and when the second radiation element is of the elliptical shape. As shown in FIG. 18, it can be found that when the second radiation element is of the elliptical shape, since the radiation element is gradually widened in the vicinity of the power supply point 33, the second radiation element has a wide operation band as compared with the case that the second radiation element shown in FIG. 16 is of the square shape. Moreover, it can be found that the band is more widened by introducing a convex portion 32 of the glass-shaped antenna.

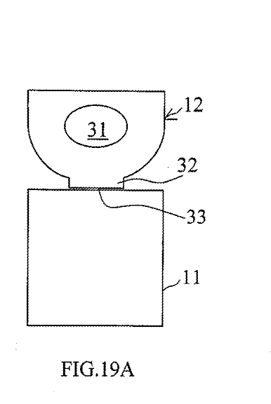

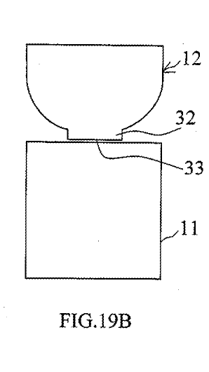

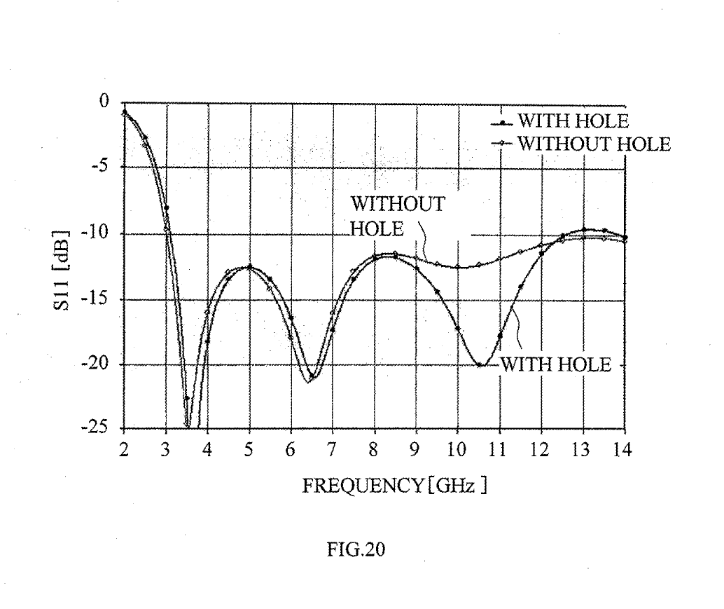

FIG. 19A and FIG. 19B show a comparative example when the wide band antenna according to the embodiment 3 has an elliptical hole and when it does not have the elliptical hole, wherein FIG. 19A shows a schematic view of the antenna when the antenna has the hole 31, and FIG. 19B shows a schematic view of the antenna when the antenna does not have the hole. FIG. 20 shows input characteristics when the wide band antenna according to the embodiment 3 has the elliptical hole and when it does not have the elliptical hole. As shown in FIG. 20, matching can be performed in a high frequency band by providing the elliptical hole 31.

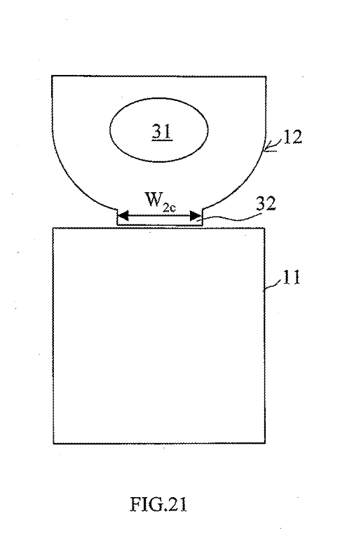

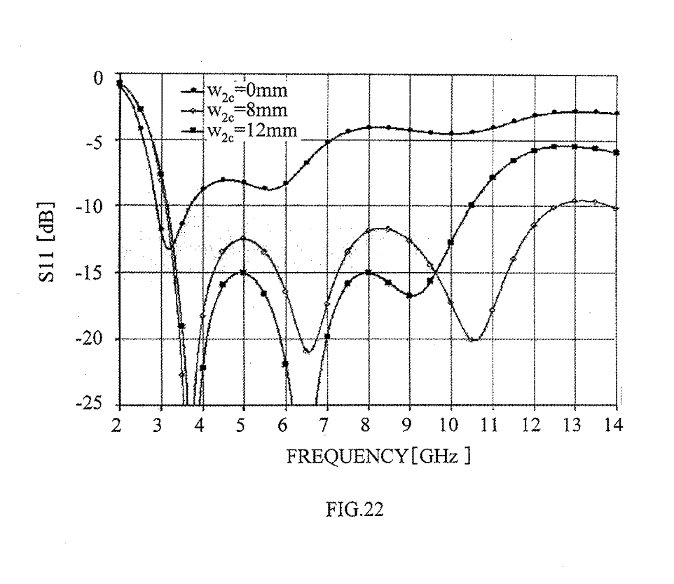

FIG. 21 shows a schematic view of the wide band antenna according to the embodiment 3 when the width W_{2c} of the convex portion 32 in the antenna is changed. FIG. 22 shows input characteristics when the width W_{2c} of the convex portion 32 in the wide band antenna according to the embodiment 3 is changed. As shown in FIG. 22, the band is widened by setting the width to W_{2c}=8 mm. As described above, the wide band antenna according to the embodiment is optimized so that the antenna operates in UWB while remaining the planar shape.

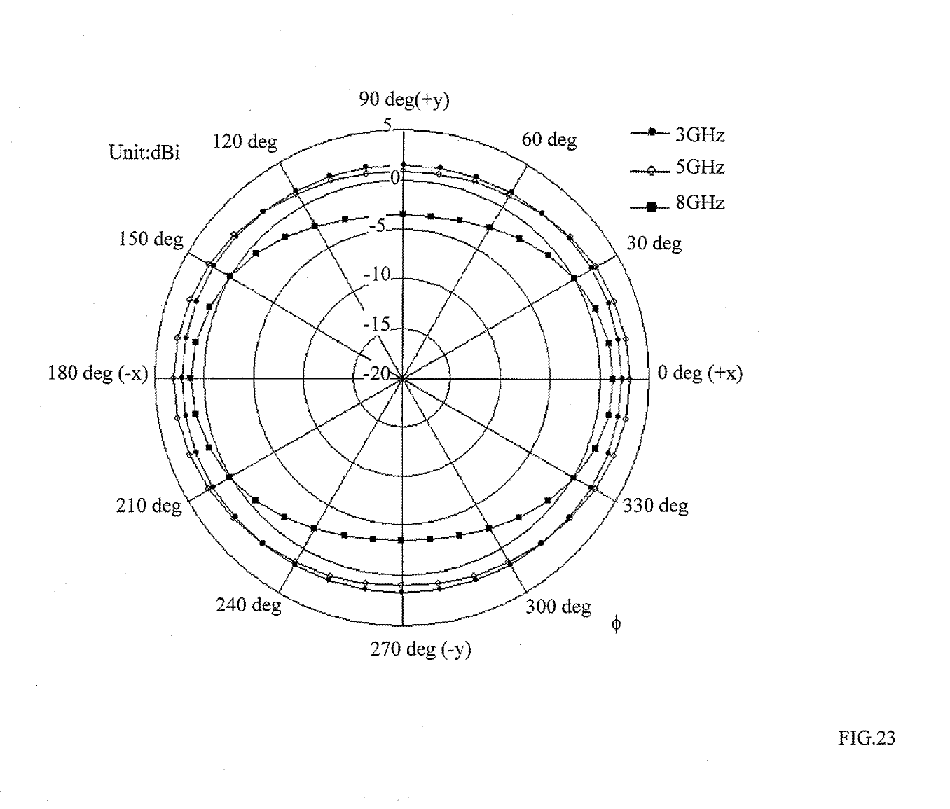

FIG. 23 shows radiation patterns on an xy surface of the wide band antenna according to the embodiment 3. When the radiation patterns were compared at 3 GHz, 5 GHz, and 8 GHz, although a pattern at 3 GHz was relatively near to a circle and non-directional at 3 GHz, as a frequency increases, patterns became collapsed in a y-axis direction.

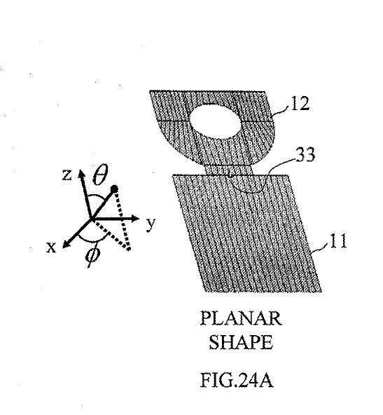

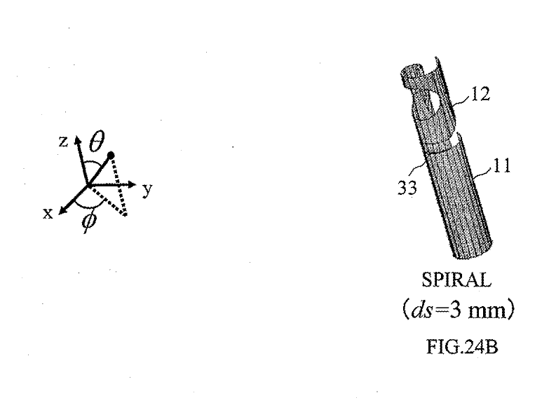

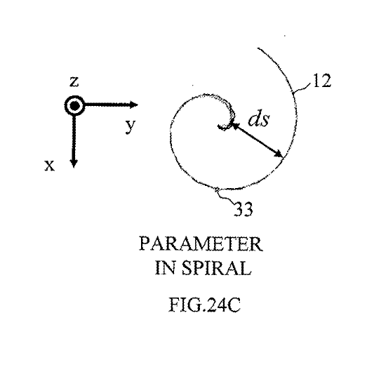

FIG. 24A, FIG. 24B and FIG. 24C shows the wide band antenna according to the embodiment 3, wherein FIG. 24A shows an antenna pattern in a planar shape, FIG. 24B shows a state that the second radiation element is rolled in a spiral shape, and FIG. 24C shows a state that the second radiation element rolled in the spiral shape is viewed from thereabove. In the wide band antenna according to the embodiment 3, the second radiation element 12 and the first radiation element 11 shown in FIG. 14 are rolled in the spiral shape at a space ds between spiral layers. The antenna can be simply made by bonding a flexible dielectric sheet having a uniform thickness on a metal film antenna and rolling the metal film antenna in a circular shape.

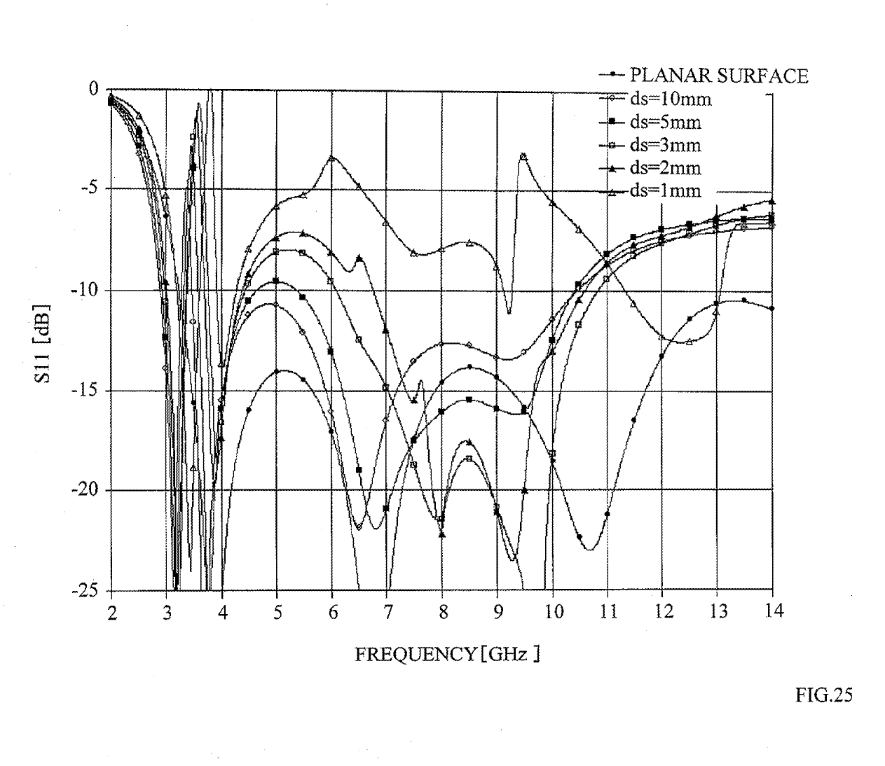

FIG. 25 shows input characteristics of the wide band antenna according to the embodiment 3 when the space between the spiral layers is changed. As illustrated, when the planar antenna is rolled in the spiral shape, although the input characteristics are somewhat deteriorated, characteristics necessary to a UWB wireless communication is kept. When, for example, ds=3 mm, |S11|≦−8 dB can be achieved at 3.7 GHz to 10.6 GHz which is sufficiently practically usable level. It can be found that when ds=1 mm, the minimum operating frequency increases, |S11| in a region increases, and the wide band characteristics begin to be deteriorated.

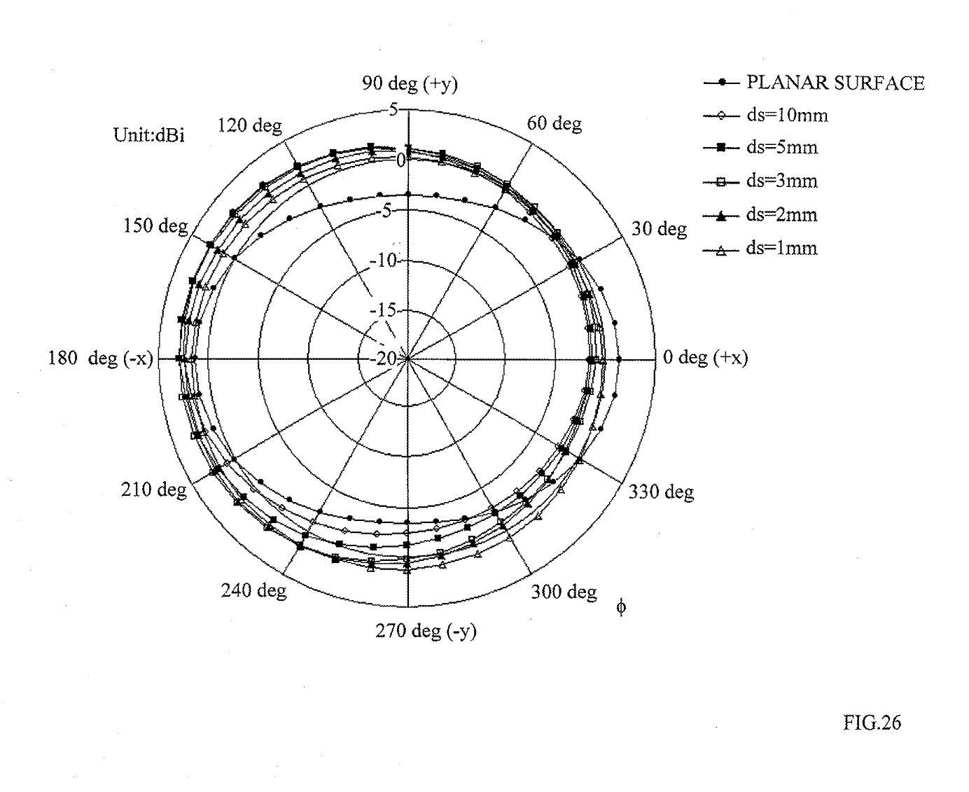

FIG. 26 shows a radiation pattern on the xy surface of the wide band antenna according to the embodiment 3 at 8 GHz. As illustrated, the radiation pattern of the antenna rolled in the spiral shape is nearer to a non-directional state than the planar antenna and can obtain better transmission characteristics when the UWB wireless communication is performed.

### Embodiment 4

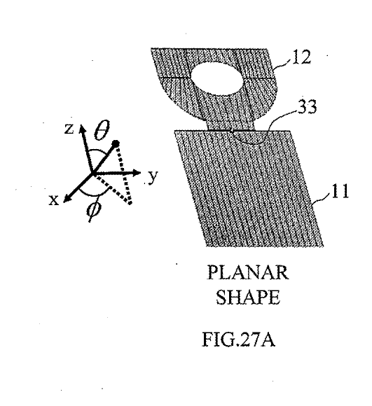

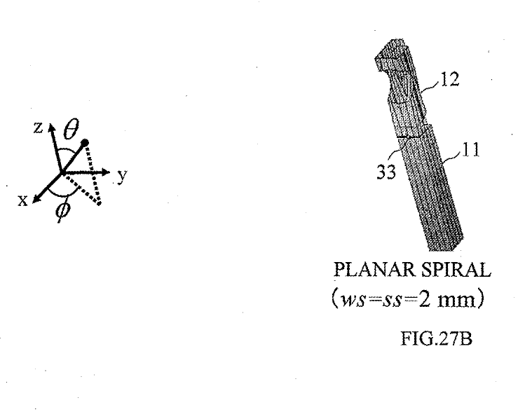

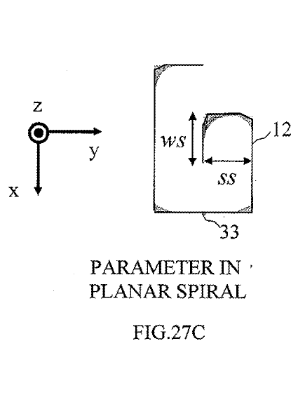

FIG. 27A, FIG. 27B and FIG. 27C shows a wide band antenna according an embodiment 4, wherein FIG. 27A shows an antenna pattern in a planar shape, FIG. 27B shows a state that a second radiation element is rolled in a planar spiral shape, and FIG. 27C shows a state that the second radiation element rolled in the planar spiral shape is viewed from thereabove. In the wide band antenna according the embodiment 4, the second radiation element 12 and the first radiation element 11 shown in FIG. 14 are rolled in the planar spiral shape so that a space between spiral layers in a y-direction becomes ss and a space between spiral layers in an x-direction becomes ws.

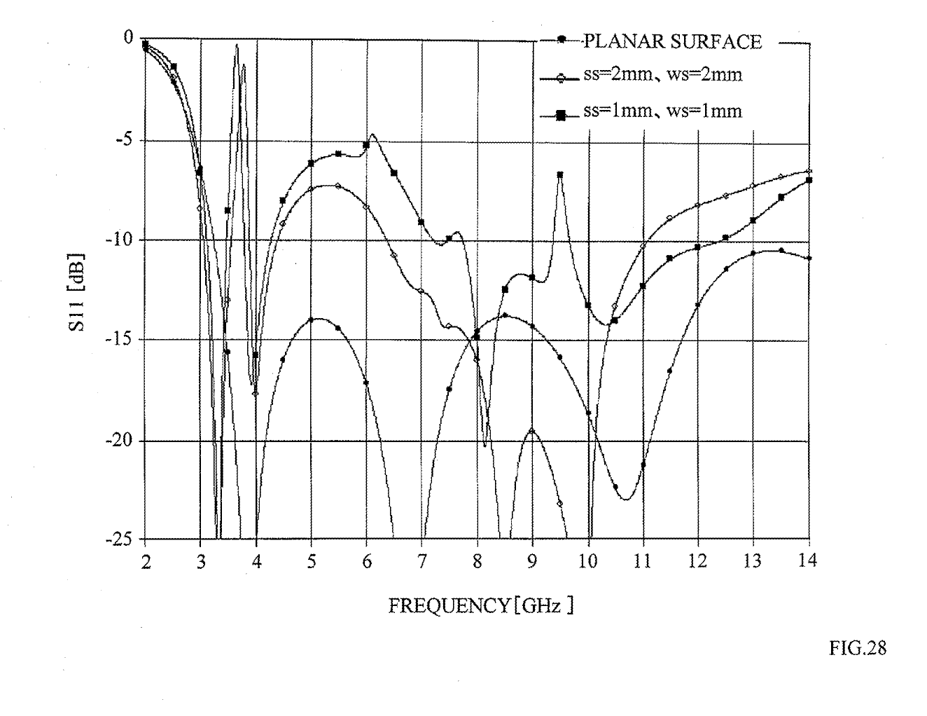

FIG. 28 shows input characteristics of the wide band antenna according to the embodiment 4 when spaces between planar spiral layers are changed. As illustrated, the antenna rolled in the planar spiral shape keeps characteristics necessary to the UWB wireless communication although input characteristics are somewhat deteriorated. The characteristics begin to deteriorate at ss=ws=1 mm.

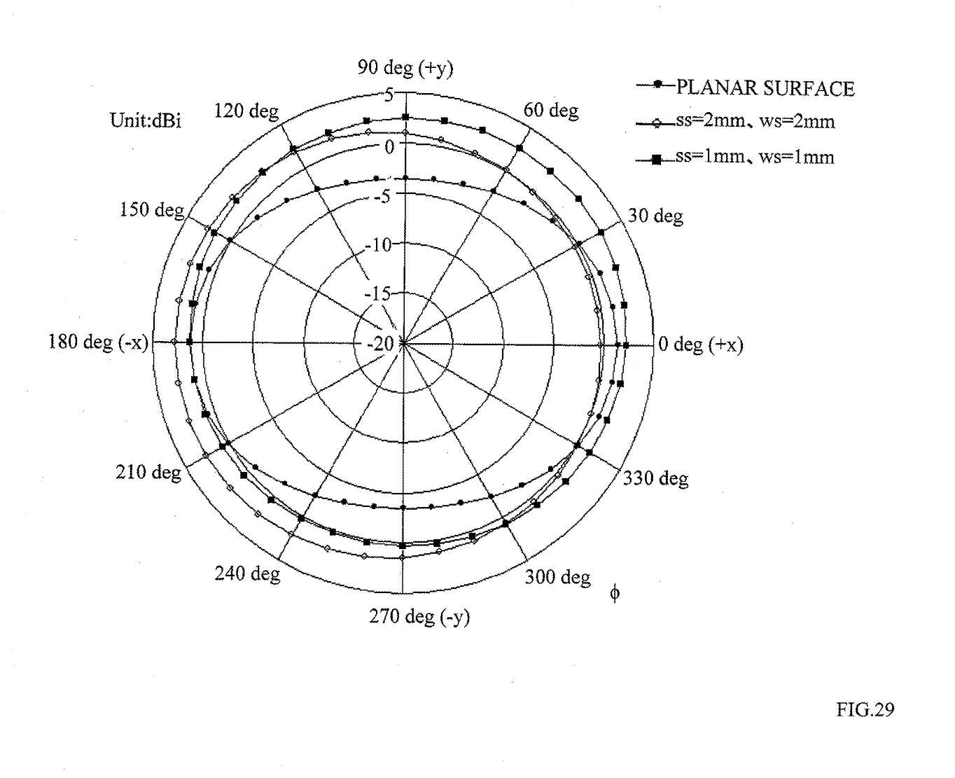

FIG. 29 shows a radiation pattern on an xy surface of the wide band antenna according to the embodiment 4 at 8 GHz. As illustrated, the radiation pattern of the antenna rolled in the planar spiral shape is nearer to a non-directional state than a planar antenna, and when the UWB wireless communication is performed, better transmission characteristics can be obtained.

### Embodiment 5

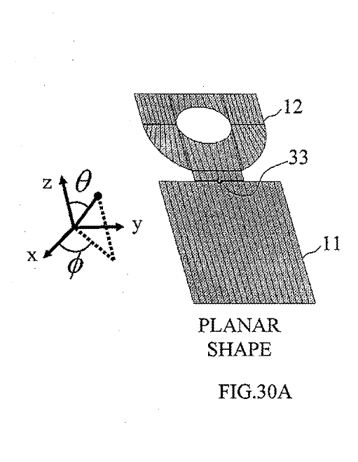

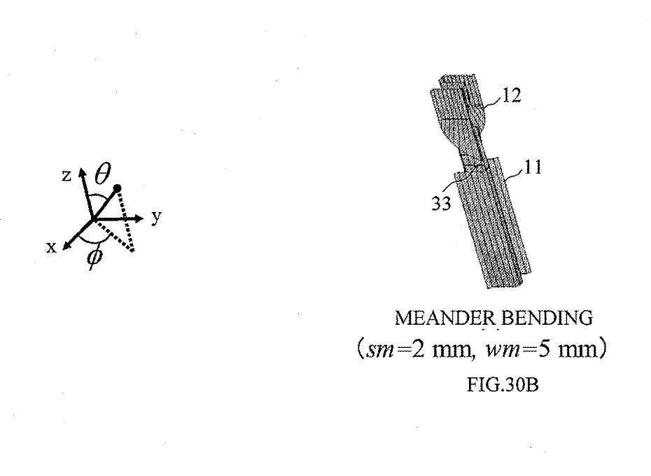

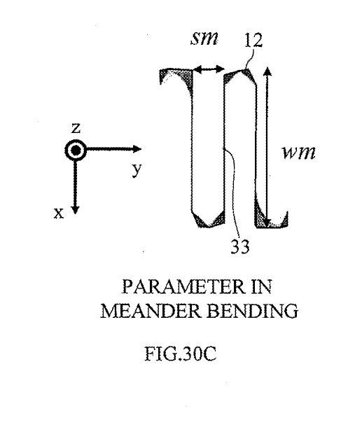

FIG. 30A, FIG. 30B and FIG. 30C shows a wide band antenna according to an embodiment 5, wherein FIG. 30A shows an antenna pattern in a planar shape, FIG. 30B shows a state that a second radiation element is bent in a meander shape, and FIG. 30C shows a state when the second radiation element bent in the meander shape is viewed from thereabove. In the wide band antenna according to the embodiment 5, the second radiation element 12 and the first radiation element 11 shown in FIG. 14 are formed by bending a planar antenna in the meander shape so that the width of meanders and a space sm between meander layers in a y-direction have a constant value and a width wm of the meanders in an x-direction has a constant value. The wide band antenna according to the embodiment 5 can be simply made by inserting a dielectric block between (into a space of) the meander layers of metal films of the radiation elements.

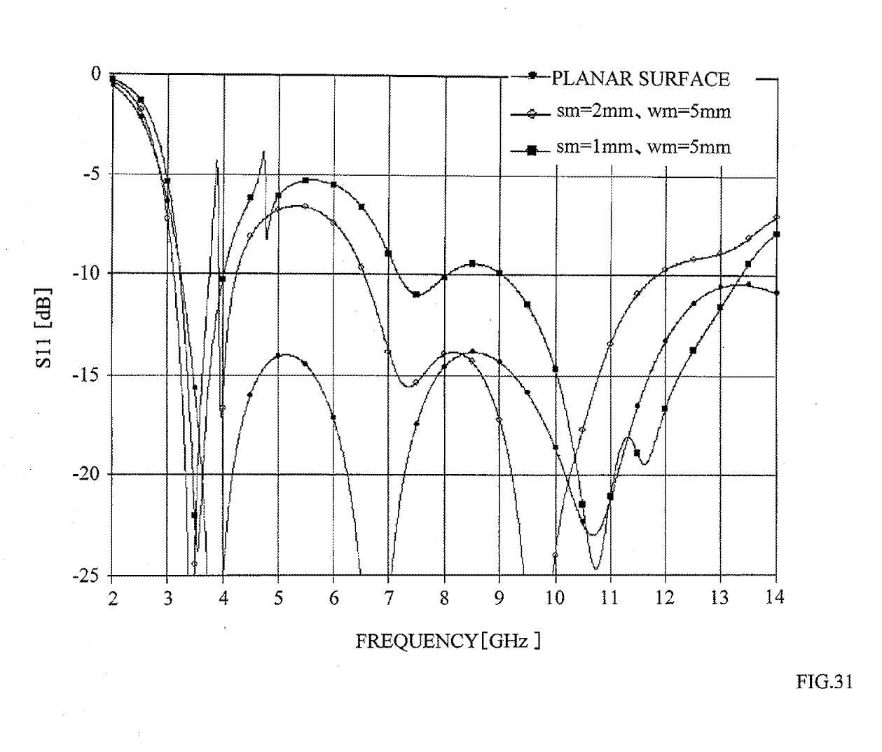

FIG. 31 shows input characteristics of the wide band antenna according to the embodiment 5 when the space sm between the meander layers are changed. As illustrated, the antenna bent in the meander shape keeps characteristics necessary to the UWB wireless communication although input characteristics are somewhat deteriorated. Characteristics begin to deteriorate at sm=1 mm.

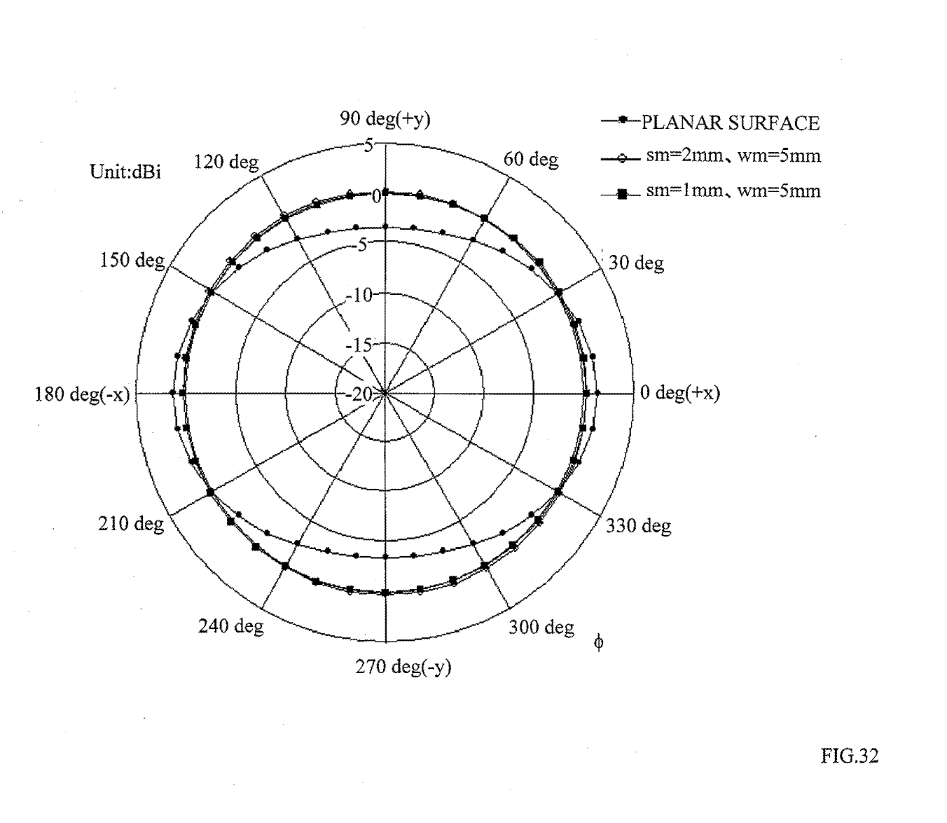

FIG. 32 shows a radiation pattern on an xy surface of the wide band antenna according to the embodiment 5 at 8 GHz. As illustrated, the radiation pattern of the antenna bent in the meander shape is nearer to the non-directional state than the planar antenna, and when the UWB wireless communication is performed, better transmission characteristics can be obtained.

### Embodiment 6

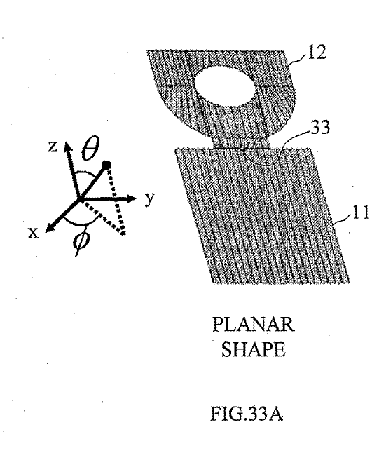

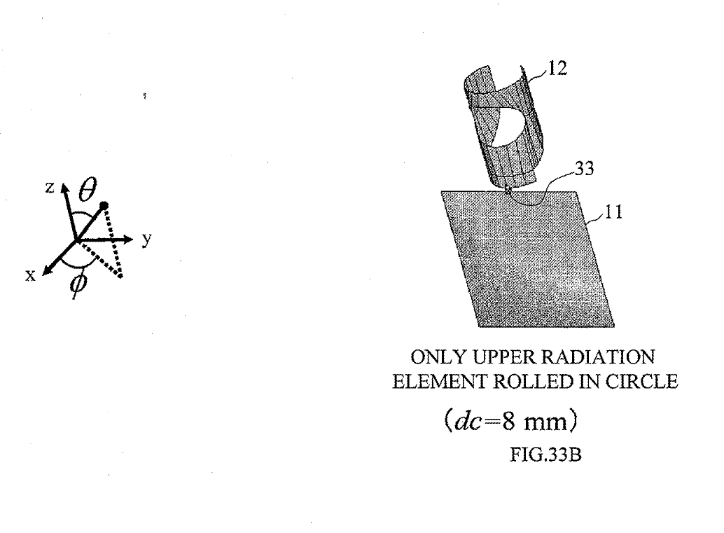

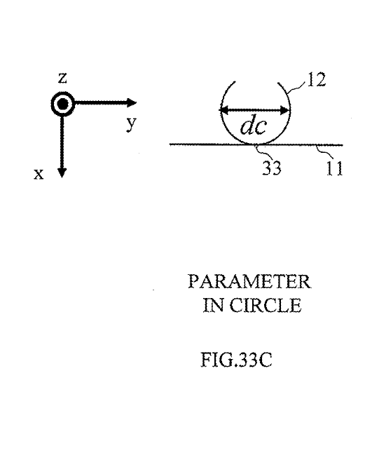

FIG. 33A, FIG. 33B and FIG. 33C shows a wide band antenna according to an embodiment 6, wherein FIG. 33A shows an antenna pattern in a planar shape, FIG. 33B shows a state that a second radiation element is rolled in a circular roll shape, and FIG. 33C shows a state that the second radiation element rolled in the circular roll shape is viewed from thereabove. In the wide band antenna according to the embodiment 6, only the second radiation element 12 shown in FIG. 14 is rolled in a circular roll shape having a diameter dc.

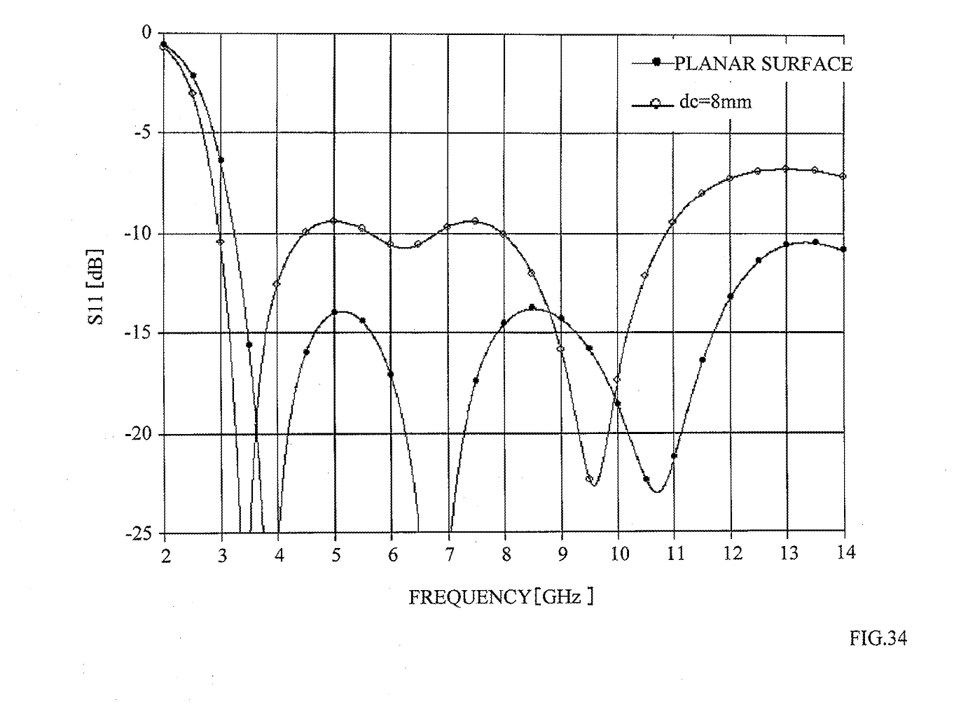

FIG. 34 shows input characteristics of the wide band antenna according to the embodiment 6 when the diameter dc of the circular roll is set to 8 mm. As illustrated, the antenna made by rolling the second radiation element 12 in the circular shape keeps characteristics necessary to the UWB wireless communication although input characteristics are somewhat deteriorated.

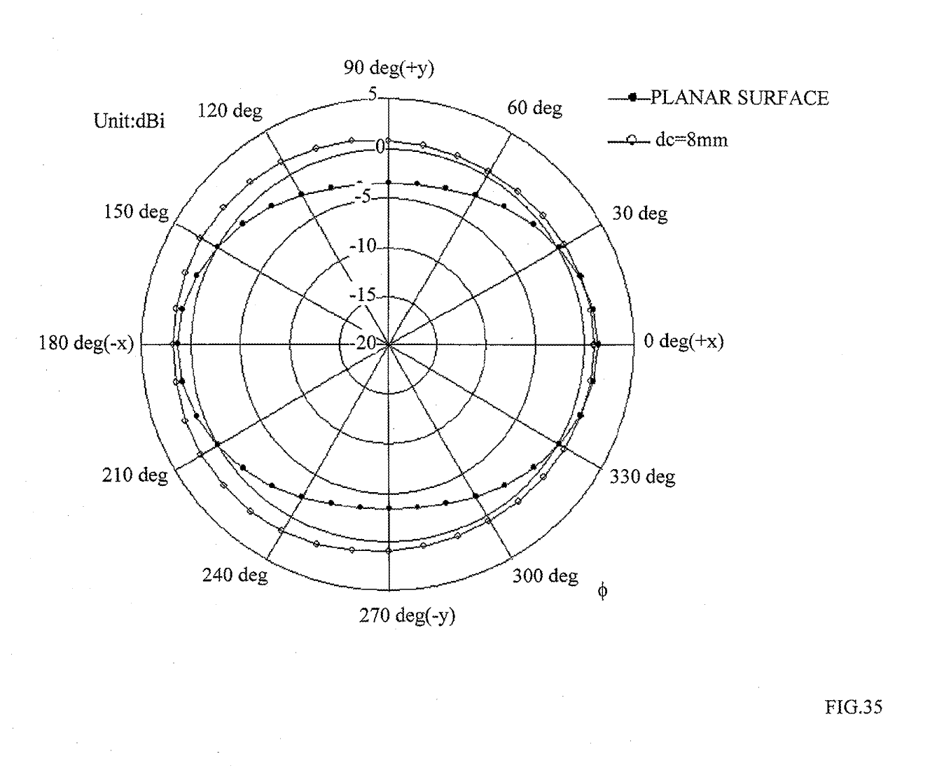

FIG. 35 shows a radiation pattern on an xy surface of the wide band antenna according to the embodiment 6 at 8 GHz. As illustrated, the radiation pattern of the antenna in which the second radiation element 12 is rolled in the circular roll shape is nearer to the non-directional state than the planar antenna, and when the UWB wireless communication is performed, better transmission characteristics can be obtained.

### Embodiment 7

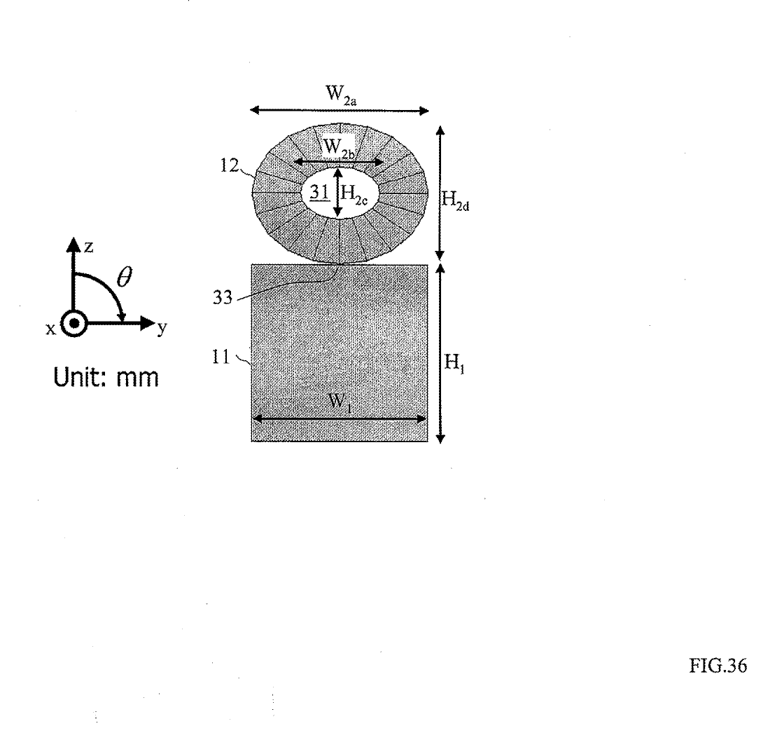

FIG. 36 shows an antenna pattern of a wide band antenna according to an embodiment 7. In the wide band antenna according to the embodiment 7, the outside shape of a second radiation element 12 is of an elliptical shape, and an elliptical hole 31 is defined to the center of the second radiation element 12. The lateral width W₂ₐ of the second radiation element 12 is 20 mm, the height H_{2d} of the second radiation element 12 is 16 mm, the lateral width W_{2b} of the elliptical hole 31 is 9 mm, the height H_{2c} of the elliptical hole 31 is 6 mm, the lateral width W₁ of a first radiation element 11 is 20 mm, and the height H₁ of the first radiation element 11 is 20 mm.

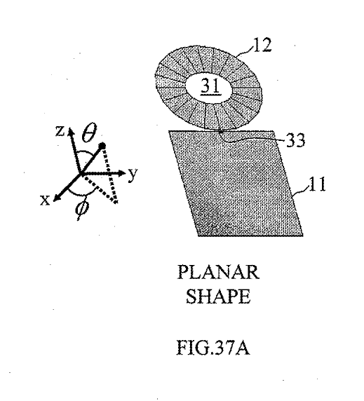

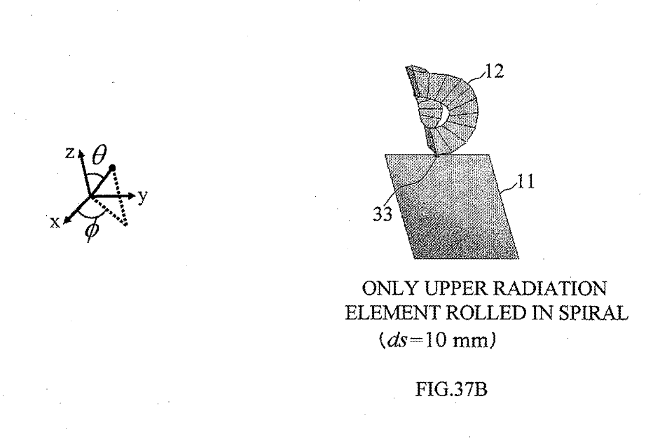

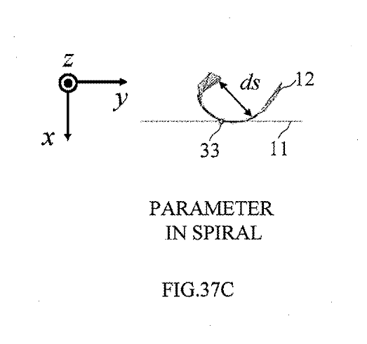

FIG. 37A, FIG. 37B and FIG. 37C shows the wide band antenna according to the embodiment 7, wherein FIG. 37A shows an antenna pattern in a planar shape, FIG. 37B shows a state that an second radiation element is rolled in a spiral shape, and FIG. 37C shows the second radiation element rolled in the spiral shape when the second radiation element is viewed from thereabove. In the wide band antenna according to the embodiment 7, the second radiation element 12 shown in FIG. 36 is rolled in the spiral shape so that a space ds between spiral layers has a constant value.

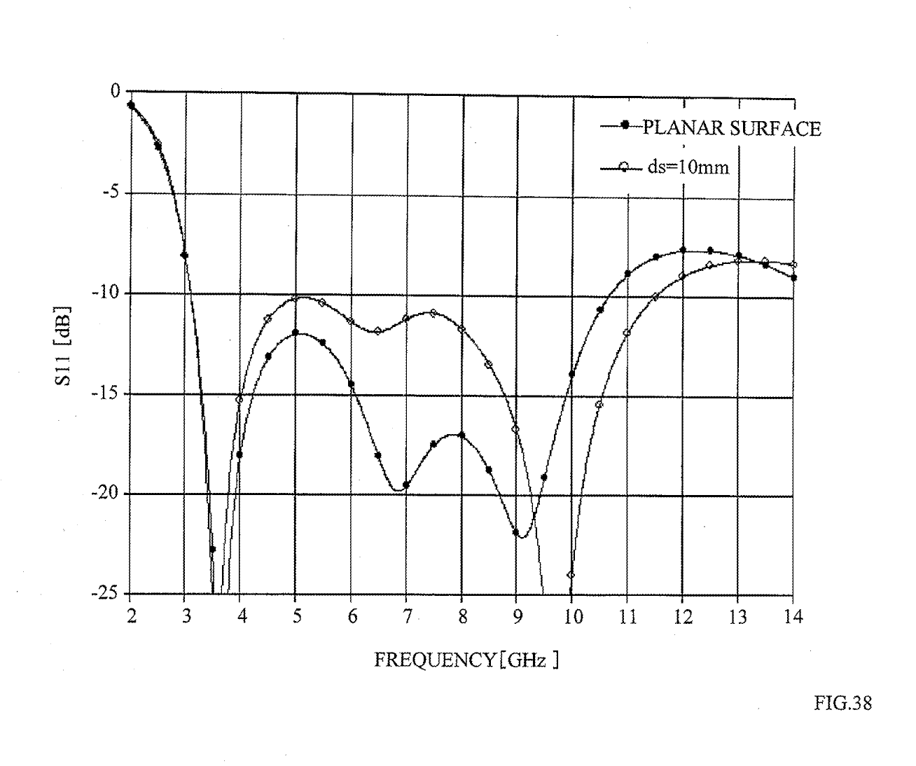

FIG. 38 shows input characteristics of the wide band antenna according to the embodiment 7 when the space ds between the spiral layers is set to 10 mm. As illustrated, the antenna made by rolling the second radiation element 12 in the spiral shape keeps characteristics necessary to the UWB wireless communication although input characteristics are somewhat deteriorated.

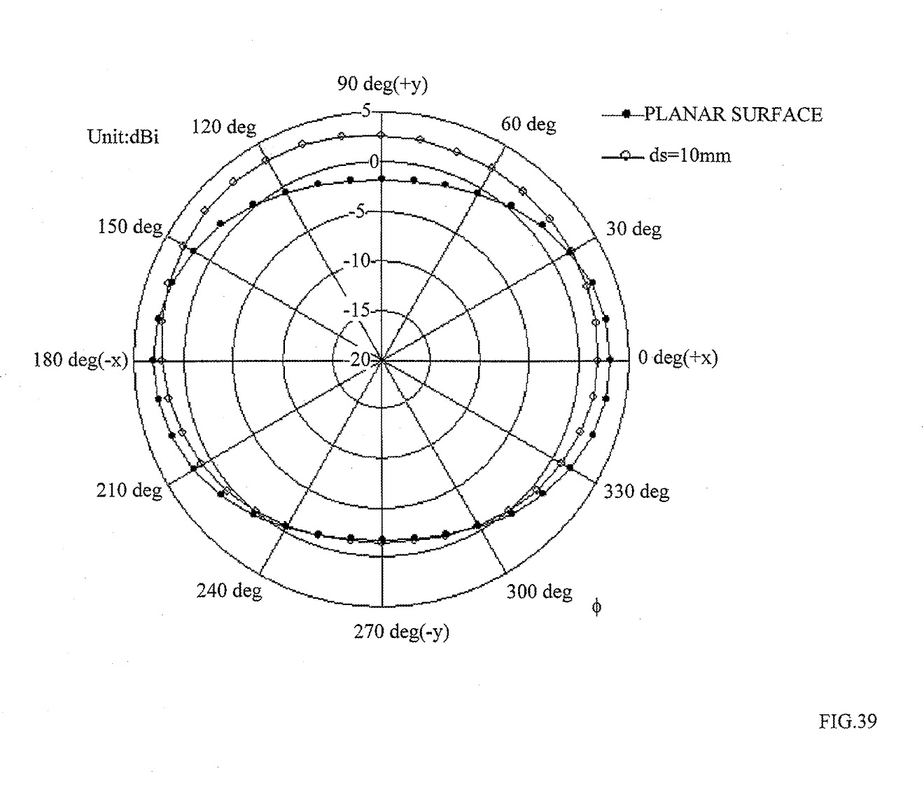

FIG. 39 shows a radiation pattern on an xy surface of the wide band antenna according to the embodiment 7 at 8 GHz. As illustrated, the antenna rolled in the spiral shape is nearer to the non-directional state than the planar antenna, and when the UWB wireless communication is performed, better transmission characteristics can be obtained.

### Embodiment 8

FIG. 40A and FIG. 40B shows a wide band antenna according to an embodiment 8, wherein FIG. 40A shows a case that a power supply point is disposed inside a first radiation element and FIG. 40B shows a case that the power supply point is disposed outside the first radiation element. The outside means here that when a second radiation element 12 is projected to the first radiation element 11 in parallel with the disposition direction of the second radiation element 12 and the first radiation element 11, the width of the second radiation element 12 is located outside the width of the first radiation element 11. When the power supply point 33 is disposed inside the first radiation element 11, if the second radiation element 12 and the first radiation element 11 are disposed in a z-axis direction as shown in FIG. 40A, the power supply point 33 is disposed to the end of the first radiation element 11 in a y-axis direction.

When the power supply point 33 is disposed outside the first radiation element 11, if the second radiation element 12 and the first radiation element 11 are disposed in the z-axis direction as shown in FIG. 40B, the power supply point 33 is disposed outside the end of the first radiation element 11 in the y-axis direction. In the planar antenna, when a power supply position is disposed to the end as shown in FIG. 40A and FIG. 40B, when the planar antenna is bent, the power supply position can be located on an innermost side or on an outermost side.

In the cases of FIG. 40A and FIG. 40B, when, for example, the planar antenna is rolled in a spiral shape so that the end in a +y-direction is located inside, the power supply point 33 can be disposed on the innermost side. In the case, since the power supply point 33 can be protected inside the antenna, a radiation by a power supply cable can be suppressed.

Further, when the planar antenna is rolled in the spiral shape so that the end in a −y-direction is located inside, the power supply point 33 can be disposed outside. With the configuration, since the power supply cable can be attached after the antenna is bent, the antenna can be manufactured and inspected easily.

Since the wide band antenna can be made compact by bending a planar antenna composed of a metal film, the wide band antenna can be mounted on the small wireless equipment. Futher, with the configuration, since the non-directionality of the antenna can be improved, the UWB communication can be efficiently performed.

### INDUSTRIAL APPLICABILITY

The invention can be used to an antenna built in an information terminal equipment such as a notebook computer, a PDA (personal digital assistant) terminal, a mobile phone, a VICS (vehicle information and communication system), and the like.

1. A wide band antenna comprising:
a first radiation element; and
a second radiation element,
wherein the second radiation element is bent on a first straight line which is approximately parallel with the disposition direction of the second radiation element and the first radiation element or rolled in a cylindrical shape using a straight line approximately parallel with the first straight line as an axis direction.

2. The wide band antenna according to claim 1 in which the second radiation element and the first radiation element are disposed on the same surface, wherein the second radiation element and the first radiation element are bent on a straight line which is approximately parallel with the disposition direction of the second radiation element and the first radiation element or rolled in a cylindrical shape using a straight line approximately parallel with the first straight line as an axis direction.

3. The wide band antenna according to claim 1, wherein
the second radiation element and the first radiation element are formed in a loop shape;
the shapes of the outer peripheries of the second radiation element and the first radiation element are line-symmetrical to the first straight line; and
the shapes of the outer peripheries of the second radiation element and the first radiation element in a proximity portion where the second radiation element confronts the first radiation element are line-symmetrical to a second straight line orthogonal to the first straight line.

4. The wide band antenna according to claim 1, wherein
the proximity portion where the second radiation element confronts the first radiation element further comprises a first convex portion in which a part of the outer periphery of the first radiation element is formed in a convex shape and a second convex portion in which a part of the outer periphery of the second radiation element is formed in a convex shape; and
the edges of the first convex portion and the second convex portion which confront each other are parallel with each other.

5. The wide band antenna according to claim 1, wherein
as the distance between the second radiation element and the first radiation element increases, the width of the second radiation element is increased from the position where the second radiation element is nearest to the first radiation element to the position of a predetermined height in the disposition direction of the second radiation element and the first radiation element; and
when the wavelength of a minimum operating frequency is shown by λ₀, the width of a projected shape of the second radiation element in the disposition direction of the second radiation element and the first radiation element is 0.12λ₀ or more to 0.5λ₀ or less in a lateral width.

6. The wide band antenna according to claim 1, wherein the second radiation element is bent or rolled to two or more layers, an interlayer shortest distance is 0.005λ₀ or more, and an interlayer longest distance is 0.1λ₀ or less.

7. The wide band antenna according to claim 1, wherein the shape of the second radiation element in a section orthogonal to the first straight line is a spiral shape, a planar spiral shape, a part of a circular shape, or a meander shape or a combination of these shapes.

8. The wide band antenna according to claim 1, wherein the second radiation element comprises metal films laminated on a dielectric sheet.

9. The wide band antenna according to claim 8, wherein the second radiation element comprises a dielectric block inserted between the metal films.

10. The wide band antenna according to claim 1, wherein a power supply point of the second radiation element is disposed to an end in a direction approximately orthogonal to the disposition direction of the second radiation element and the first radiation element.

11. The wide band antenna according to claim 2, wherein
the second radiation element and the first radiation element are formed in a loop shape;
the shapes of the outer peripheries of the second radiation element and the first radiation element are line-symmetrical to the first straight line; and
the shapes of the outer peripheries of the second radiation element and the first radiation element in a proximity portion where the second radiation element confronts the first radiation element are line-symmetrical to a second straight line orthogonal to the first straight line.

12. The wide band antenna according to claim 2, wherein
the proximity portion where the second radiation element confronts the first radiation element further comprises a first convex portion in which a part of the outer periphery of the first radiation element is formed in a convex shape and a second convex portion in which a part of the outer periphery of the second radiation element is formed in a convex shape; and
the edges of the first convex portion and the second convex portion which confront each other are parallel with each other.

13. The wide band antenna according to claim 2, wherein
as the distance between the second radiation element and the first radiation element increases, the width of the second radiation element is increased from the position where the second radiation element is nearest to the first radiation element to the position of a predetermined height in the disposition direction of the second radiation element and the first radiation element; and
when the wavelength of a minimum operating frequency is shown by λ₀, the width of a projected shape of the second radiation element in the disposition direction of the second radiation element and the first radiation element is 0.12λ₀ or more to 0.5λ₀ or less in a lateral width.

14. The wide band antenna according to claim 2, wherein the second radiation element is bent or rolled to two or more layers, an interlayer shortest distance is 0.005λ₀ or more, and an interlayer longest distance is 0.1λ₀ or less.

15. The wide band antenna according to claim 2, wherein the shape of the second radiation element in a section orthogonal to the first straight line is a spiral shape, a planar spiral shape, a part of a circular shape, or a meander shape or a combination of these shapes.

16. The wide band antenna according to claim 2, wherein the second radiation element comprises metal films laminated on a dielectric sheet.

17. The wide band antenna according to claim 2, wherein a power supply point of the second radiation element is disposed to an end in a direction approximately orthogonal to the disposition direction of the second radiation element and the first radiation element.

18. The wide band antenna according to claim 3, wherein
the proximity portion where the second radiation element confronts the first radiation element further comprises a first convex portion in which a part of the outer periphery of the first radiation element is formed in a convex shape and a second convex portion in which a part of the outer periphery of the second radiation element is formed in a convex shape; and
the edges of the first convex portion and the second convex portion which confront each other are parallel with each other.

19. The wide band antenna according to claim 3, wherein
as the distance between the second radiation element and the first radiation element increases, the width of the second radiation element is increased from the position where the second radiation element is nearest to the first radiation element to the position of a predetermined height in the disposition direction of the second radiation element and the first radiation element; and
when the wavelength of a minimum operating frequency is shown by λ₀, the width of a projected shape of the second radiation element in the disposition direction of the second radiation element and the first radiation element is 0.12λ₀ or more to 0.5λ₀ or less in a lateral width.

20. The wide band antenna according to claim 3, wherein the second radiation element is bent or rolled to two or more layers, an interlayer shortest distance is 0.005λ₀ or more, and an interlayer longest distance is 0.1λ₀ or less.

21. The wide band antenna according to claim 3, wherein the shape of the second radiation element in a section orthogonal to the first straight line is a spiral shape, a planar spiral shape, a part of a circular shape, or a meander shape or a combination of these shapes.

22. The wide band antenna according to claim 3, wherein the second radiation element comprises metal films laminated on a dielectric sheet.

23. The wide band antenna according to claim 2, wherein a power supply point of the second radiation element is disposed to an end in a direction approximately orthogonal to the disposition direction of the second radiation element and the first radiation element.
